(19) United States
(12) Patent Application Publication
(10) Pub. No.: US 2005/0182659 A1
(43) Pub. Date: Aug. 18, 2005

(54) Cost sensitivity decision tool for predicting and/or guiding health care decisions

(76) Inventor: Christine C. Huttin, Cambridge, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/051,565

(22) Filed: Feb. 4, 2005

Related U.S. Application Data
(60) Provisional application No. 60/542,216, filed on Feb. 6, 2004.

(51) Int. Cl. G06F 17/60

(52) U.S. Cl. 705/2

(57) ABSTRACT

Methods, devices and systems are disclosed that may be used as a predictive tool for disease surveillance, may be implemented for cost management of delivered health care within a managed care structure, and may be implemented for market simulation for product testing or introduction.

### PRIORITY CLAIM

This application claims the benefit of U.S. Provisional Patent Application No. 60/542,216 filed Feb. 6, 2004, the entire disclosure of which is incorporated herein by reference for all purposes.

### FIELD OF THE INVENTION

Certain examples disclosed herein relate generally to methods, systems and devices for predicting health care treatment shifts and/or for selecting a health care decision. More particularly, certain examples relate to methods, systems and devices that generate cost sensitivity indices for use in predicting health care treatment shifts and/or selecting a heath care decision.

### BACKGROUND

Health care costs are a major issue in most countries, especially in the American policy debate both in Canada and the USA. In these countries, the growth of health care expenditures as a percentage of the gross domestic product is one of the highest in the world and is continuing to increase. There remains a need for better tools to predict health care treatment shifts and to assess health care decisions and costs.

### SUMMARY

In accordance with a first aspect, a cost sensitivity decision tool is provided. In certain examples, the cost sensitivity decision tool accounts for one or more cues or variables that can affect health care decisions, outcomes, expenditures and the like. The cost sensitivity decision tool may be used, for example, to predict treatment decision shifts, to guide or to assist health care providers in making treatment decisions, or to assess the potential market for a drug or therapeutic. The cost sensitivity decision tool may also be used to link health care decisions with economic models and/or predictive treatment decision shifts. Health care outcomes and treatments may be guided by such shifts. Additional uses of the cost sensitivity decision tool will be readily selected by the person of ordinary skill in the art, given the benefit of this disclosure.

In accordance with another aspect, a method of predicting a treatment decision shift is disclosed. In certain examples, the method includes selecting at least one variable. The method may further include generating a cost sensitivity index using one or more responses to the selected at least one variable. The method may also include generating a treatment decision shift using the generated cost sensitivity index.

In accordance with another aspect, a method of selecting a treatment decision is provided. In certain examples, the method includes selecting at least one variable. The method may also include generating a cost sensitivity index using one or more responses to the selected variable. The method may further include generating a treatment decision using the generated cost sensitivity index.

In accordance with another aspect, a method of determining a treatment decision shift is disclosed. In certain examples, the method includes surveying a health care provider. The method may further include generating a cost sensitivity index using survey results from the surveying of the health care provider. The method may further include determining a treatment decision shift using the generated cost sensitivity index.

In accordance with an additional aspect, a method of determining a treatment decision shift is provided. In certain examples, the method may include surveying a group of patients. The method may also include generating a quality index based on survey results from the surveying of the group of patients. The method may further include determining a treatment decision shift using the generated quality index.

In accordance with an additional aspect, a method of determining a treatment decision shift is disclosed. In certain examples, the method may include surveying a group of patients. The method may also include generating a risk index based on survey results from the surveying of the group of patients. The method may further include determining a treatment decision shift using the generated risk index.

In accordance with another aspect, a system that is configured to predict treatment decision shifts is disclosed. In certain examples, the system is operative to predict treatment decision shifts using an index selected from one or more of a cost sensitivity index, a quality index or a risk index.

In accordance with an additional aspect, a system that is configured to predict treatment decisions is provided. In certain examples, the system is operative to predict treatment decisions using an index selected from one or more of a cost sensitivity index, a quality index or a risk index.

In accordance with another aspect, a system that is configured to predict treatment decisions is disclosed. In certain examples, the system is operative to perform a market simulation using an index selected from one or more of a cost sensitivity index, a quality index or a risk index.

It will be recognized by the person of ordinary skill in the art, given the benefit of this disclosure, that the technology disclosed herein provides significant benefits not achievable using prior existing technologies. Health care treatment shifts and health care decisions can be predicted that take into account patient's economic information as well as physician practices. Certain features and aspects disclosed herein may be implemented as a predictive tool for disease surveillance, market testing, expenditures, managing costs and the like. Validation information for prediction and simulation of expenditures, health status may also be generated. The impacts of treatment decision shifts on expenditures and market simulations may be predicted. Additional uses of the methods, devices and systems disclosed herein will be readily selected by the person of ordinary skill in the art, given the benefit of this disclosure. These and other advantages, features, aspects and examples are discussed in detail below.

### BRIEF DESCRIPTION OF THE DRAWINGS

Certain examples are described below with reference to the accompanying drawings in which:

FIG. 1 is a first block diagram, in accordance with certain examples;

FIG. 2A is a second block diagram, in accordance with certain examples;

FIG. 2B is a third block diagram, in accordance with certain examples;

FIGS. 3-23 are examples of forms that may be used to inquire about patient satisfaction variables, in accordance with certain examples;

FIG. 24 is a block diagram of another examples, in accordance with certain examples;

FIG. 25 is a schematic of computer system suitable for implementing examples of the methods disclosed herein, in accordance with certain examples;

FIG. 26 is an example of a storage system, in accordance with certain examples;

FIGS. 27 and 28 are graphs showing treatment decision shifts for hypertension drugs in two countries, in accordance with certain examples; and

FIG. 29 is a graph showing treatment decision shifts for hay fever drugs, in accordance with certain examples.

It will be apparent to the person of ordinary skill in the art, that the figures are illustrative of only some of the features and aspects of the technology disclosed herein.

### DETAILED DESCRIPTION

Examples of the methods, systems and devices disclosed herein allow for prediction of treatment decision shifts by taking into account variables not presently considered in existing health care decision software and programs. For example, the methods disclosed herein may be used to select treatment that are likely to be followed by a patient, versus a treatment that may be prescribed for the patient but due to cost reasons, the patient cannot or does not intend to follow. Examples of the methods may also be used to predict or track shifts in treatment decision by comparing indices over time, e.g., comparing a current cost sensitivity index to a reference cost sensitivity index. Examples of the method may further be used to assess the marketability or desire for a new drug. For example, a cost sensitivity index, or other suitable index, may be established to assess whether or not a new drug would be prescribed by health care providers for a selected disease or disorder. The exact number of variables considered may vary depending on the intended clinical setting, e.g., hospital versus primary care, the type of organization, e.g., HMO versus third-party insurance, and the available treatment regimens. It will be within the ability of the person of ordinary skill in the art, given the benefit of this disclosure, to select suitable variables in the illustrative methods, systems and devices disclosed herein.

Examples of the methods, devices and systems disclosed herein may be used for numerous different applications. In certain examples, the technology disclosed herein may be implemented as a predictive tool for disease surveillance. For example, hypothetical scenarios may be used as prospective cases to predict responses to epidemics, vaccine shortages, drug supply shortages or drug need and the like. Data obtained from such hypothetical scenarios is referred to as intention data. Such intention data may be used to link behavioral and econometric models. In other examples, the technology disclosed herein may be implemented for cost management of delivered health care within a managed care structure. For example, reports to physicians may be generated on implicit cost information and may be used to predict payment structures or services, health premiums or copays in a primary care setting. In certain other examples, the technology disclosed herein may be implemented for market simulation for product testing or introduction. For example, a market simulation may be conducted using the methods disclosed herein to assess the potential market for a new drug. Additional uses of the methods, devices and systems disclosed herein will be readily selected by the person of ordinary skill in the art, given the benefit of this disclosure.

Examples of the technology disclosed herein may take numerous forms depending on the desired use. For example and as discussed in more detail below, the technology disclosed herein may be implemented as a method, a system, a computer program, a hand-held device, or other suitable forms that can provide tools for predicting health care treatment shifts and/or selecting a health care decision. In some examples, the method is implemented using suitable hardware, e.g., a processor and one or more memory units including a suitable algorithm that implements the method. In other examples, the method is implemented using software. In yet other examples, the method is implemented using both hardware and software. Examples of hardware and software implementation are discussed in more detail below. It will be within the ability of the person of ordinary skill in the art, given the benefit of this disclosure, to implement the methods disclosed herein in suitable forms.

In certain examples, some of the variables (or results from surveying groups about the variables) that are implemented in the method may be available locally, whereas other variables may be available remotely. For example, it may be desirable to assess certain variables prior to medical work-up of a patient. Such variables may be assessed using a suitable questionnaire. For example, one or more administrative support staff at a physician's office may provide a questionnaire to a patient prior to the patient meeting with a physician. The administrative support staff person may enter the selected variables from the questionnaire into a local database. The local database may be made available to the physician prior to, or subsequent to, the physician's diagnosis of the patient so that the physician can select or design a suitable treatment plan that may include the selected variables from the patient questionnaire. Alternatively, the selected variables from the patient questionnaire may be entered into a hand-held device that is passed along to the physician prior to, during, or subsequent to physical examination of the patient. Other suitable methods of providing a physician or organization with selected variables will be readily selected by the person of ordinary skill in the art, given the benefit of this disclosure.

In certain examples of the technology disclosed herein, implicit cost variables may be accounted for in assessing health care treatment decision shifts and/or health care decisions using the technology disclosed herein. In particular, the restraining effect of implicit costs on health care treatment decision shifts and health care treatment decisions may be considered. Implicit variables, e.g., variables that capture cost awareness or cost consciousness, are not usually considered in clinical decision making. Instead, clinical decision making has been mainly influenced by scientific, clinical and economic evidence from clinical trials or by insurance policies. Implicit information may create a substantial restraint in use of certain health care treatments, which may lead to inappropriate behaviors, may restrict the use of evidence based medicine and rational decision making and may limit the efficiency of electronic reminder systems among health care providers. Certain examples provided herein take into account how such implicit variables can restrain health care decisions and how such implicit variables may affect health care treatment decision shifts. Explicit costs, e.g., operating expenditures, direct patient costs such as, for example, drug copays, etc., may also be considered in assessing health care treatment decision shifts and health care decisions. In certain examples, the implicit costs and/or explicit costs take the form of implicit cost variables and/or explicit cost variables, respectively. Such variables may be determined or assessed by surveying a suitable group or population.

Examples of the technology disclosed herein may be used to predict treatment decision shifts. For example, the number of Americans having chronic conditions in 1995 was estimated to be about 99 million (Institute for Health and Aging, University of California). This number is predicted to rise to about 167 million in 2050. The technology disclosed herein may be used to predict medical care costs for people with such chronic condition, especially those under disease management programs, and may also be used to select more cost effective treatment decisions for providing care to patients. Table 1a below shows estimates for the American market for the coverage of medical care costs.

TABLE 1a

| | | | Per capita |
|---|---|---|---|
| | | | cost for an |
| | | | American |
| | Per capita cost for an | | patient with |
| | American patient with | Per capita cost for an | one acute |
| | more than one chronic | American patient with | condition |
| | condition | one chronic condition | only |
| Medical | 4,672 dollars | 1,829 dollars | 817 dollars |
| care | | | |
| costs to be | | | |
| paid | | | |

Source: Institute for health and aging, University of California

The level of medical care costs noted above impose an increasing demand for innovative solutions especially for the elderly. Recent forecasts predict that in year 2025, the projected out of pocket spending as a share of income among American elderly will be 29.9%. (Urban Institute, Washington D.C.). Certain examples of the technology disclosed herein may be used to predict the outcomes of new and innovative solutions to existing health care crises.

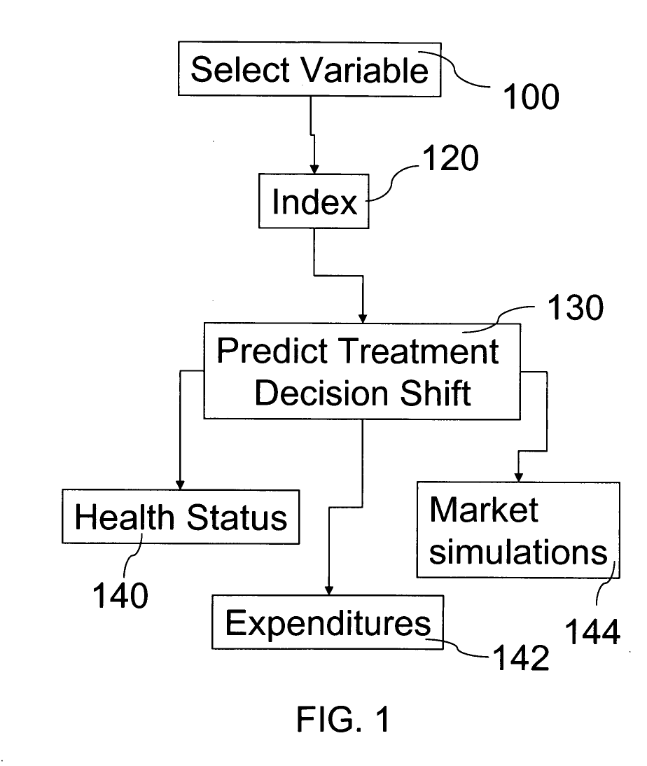

In accordance with certain examples, a method of predicting a treatment decision shift is provided. As used herein, “treatment decision shift” refers to a trend, change or alteration in the manner in which a medical treatment is chosen for a particular disease or disorder. For example, a treatment decision shift may refer to adoption of a new drug for a particular disease or disorder, adoption of a new policy for treating particular types of patients, e.g., Medicare patients, or other shifts in health care decision making. In some examples, treatment decision shifts are used to characterize the relationship between physician prescription preferences and economic costs. In other examples, treatment decision shifts may be used to predict the impact of shifts on expenditures and market simulations. Treatment decision shifts may be linked with outcomes, such as, for example, expenditures, market simulations and health status. Referring to FIG. 1, the method may include selecting a variable 100, generating an index 120, e.g., cost sensitivity index, risk index, quality index, etc., using the selected variable and predicting a treatment decision shift 130 using the generated index. Treatment decision shift 130 may be linked with health status 140, may be linked with expenditures 142 or may be linked with market simulations 144. In some examples one or more variables are selected from a list of variables, or a list of variables are generated depending on the characteristics of a patient, e.g., the disease or disorder the patient is suffering from. As discussed in more detail below, the variables are typically used to assess user responses to a specified question or statement about the variable. In some examples, the variables are used to frame a question or statement to which a response by a user is required. A variable may be referred to in some instances herein as a “cue” or a “cost cue,” and a list of variables may be referred to in certain instances herein as a “cost module.” The cost modules are typically used to calculate,a cost sensitivity index. Cost modules used in calculating the cost sensitivity index typically include one or more implicit cost cues, e.g., module on “cost to the patient” cues, module on “cost the physician” cues.

The exact nature of the variable depends on the intended target or area where determination of the treatment decision or prediction of the treatment decision shift is desired. For example, it may be desirable to select variables for surveying a patient group, a physician group, a prospective consumer group or the like. The variables may be financial variables, cost variables, consumer preference variables, physician preference variables and the like. Exemplary variables for use in the methods disclosed herein include but are not limited to financial variables such as payment of insurance premiums, net price of drugs (price paid by consumer), amount of disposable income, and whether or not a cash payment is required for a particular treatment. In some instances, conditions and views of the patient can drive the prescribing demand of the physician and therefore will influence a drugs' demand, and, thus, variables such as consumer's perception of his/her own health status may be used. Large discrepancies may exist among consumers in the total costs for medication. Patients may have to pay according to the cost of the medications they have been prescribed, and how much they are refunded by public or private insurance agencies. Variables such as whether or not an over the counter equivalent exists could also be considered.

In certain examples, a patient variable is used in the generation of a cost sensitivity index. Patient variables generally refer to the factors and conditions, e.g., costs, that a patient might consider in seeking medical treatment or in following a prescribed medical treatment. Illustrative patient variables include but are not limited to consumer price perception, patient familiarity with treatment, the type of household the patient lives in, patient's level of education, patient's sex, and patient job stability. Patient variables may also include whether or not a patient is covered by insurance and the type of insurance (e.g, voluntary insurance, Medicare, etc.). Patient variables may also include patient demand for care, patient demand for over the counter care, patient decision of prescription versus over the counter drug, and price effects.

In certain examples, the patient variables may be split up into levels. For example, a patient affordability variable may be split into the following six levels: (1) Patient with low income, without voluntary insurance and who must (can) pay in advance (for both doctor visit+medication); (2) Patient with low income, with voluntary insurance and who must (can) pay in advance; (3) Patient with low income, with voluntary insurance and third party payment for the prescription; (4) Patient with comfortable income, without voluntary insurance and that must pay in advance (cash); (5) Patient with comfortable income, with voluntary insurance and that must pay cash (visit+medicine); and (6) Patient with comfortable income, with voluntary insurance and third party for the prescription. As discussed further below, a patient may be asked to choose the particular level that applies to them, and the patient's choice can be used, e.g., scored, ranked and the like, in determining a cost sensitivity index.

In accordance with certain examples, sampling of populations is typically performed by selecting one or more inclusion criteria to construct an analytical set of data. The inclusion criteria may vary depending on the selected disease or disorder, the desired market simulation, etc. The sample can be taken from surveys at the point of visit, e.g., at the physician's office or may be taken from self-reported data, e.g., responses reported by the patient. Quality control measures are typically implemented to ensure that the sampled population is representative of the exact parameter that is to be tested or determined.

The exact type and number of patient variables may depend on the particular disease or disorder. For example, for hypertension or diabetes, the following patient variables may be used: patient affordability, patient demand for a particular treatment, comorbidities, first/repeat visit, risk factors for hypertension (family history), smoking history, disease severity and patient demand for procedures/specialist. These variables may be framed in the form of a question or statement and the patient may select the variables that are relevant to the patient, e.g., How many packs of cigarettes per week do you smoke? For asthma, the following patient variables might be used: patient has asthma without complications, patient has moderate asthma, patient has another disease contributing to asthma. The patient variable for asthma may also consider patient demand, the age of the patient, disease severity, copayment for medication or other suitable variables that may be useful in assessing suitable treatment decisions for asthma. It will be within the ability of the person of ordinary skill in the art, given the benefit of this disclosure, to select suitable variables for a selected disease or disorder.

In accordance with certain examples, a physician variable may be used to generate a cost sensitivity index. A physician variable generally describes the factors or influences that affect physician decision making in diagnosing a patient and/or prescribing a certain medication for a patient and/or other treatments, such as, for example, lifestyle changes, prevention, medical tests, exams, no treatment other kinds of trade off choices, e.g., paying for additional insurance versus choosing other therapies. This may be used for the design of physicians' choice experiments. Certain physician variables may overlap with one or more of the patient variables. Illustrative physician variables include but are not limited to: variables designed to reduce cost to the patient, access to other health care structures such as external visits in hospitals, free consultations, requests for full exemption (100% free care), delay in prescriptions, prescribe less expensive drug, prescribe generic drugs, discuss alternative treatments, etc., concerning responses to conjoint questions aiming to analyze their cost sensitivity, several types of questions, scales and modes of administrations (mail, internet, etc.) and may be tested such as: (1) With what intensity to you try to reduce the cost to the patient?; (2) Do you try to reduce the cost of treatment?; (3) Do you make substantial efforts to reduce cost? A physician may be asked to answer on a categorical, a numerical, a visual scale or other types of scales, through different modes of administration and assistive devices. The responses to the physician variables are typically used to determine a cost sensitivity index by assigning the responses a numerical score or ranking, optionally weighting the assigned scores and summing, or averaging the scores to provide a cost sensitivity index.

In certain examples of the behavioral questionnaires, physician variables may be selected based on the disease or disorder to be treated. For example, for an asthmatic patient, a physician will respond to clinical cases where cost related cues concerning the patient include: patient's demand, disease severity, copayment for medication and devices, etc. For hypertension, the following physician variables might be used: patient affordability, patient demand, comorbidities, first/repeat visit, risk factors for hypertension (family history), smoking history, disease severity and patient demand for procedures/specialist.

In accordance with certain examples, levels of the various variables can be considered for the clinical judgment analysis. Such levels may be referred to in some instances herein as “cue levels” or “thresholds.” Such cue levels of thresholds may be considered for clinical judgment and analysis of a disease. For example a variable, such as the patient affordability cue, may be broken into the following levels: (1) Consumer pays the total price and is not refunded; (2) Consumer pays the total price and is partially reimbursed; (3) Consumer pays a reduced price and third party pays the rest; (4) Consumer pays a reduced price and remainder is subsidized; and (5) Consumer pays nothing for the drug. A user, e.g., physician, patient, etc., can select which level applies and the selected level can be used in generating a cost index, e.g., by assigning the selection a score.

In accordance with certain examples, one or more variables may be weighted or scaled relative to the other variables. In certain examples, the weights associated with each variable results from one or more surveys on sampled physicians and are based, at least in part, on how cost sensitivity the physicians are to the surveyed cost cues. An example of calculating a cost sensitivity index using weighting factors is discussed below. Additional strategies of weighting the variables will be readily selected by the person of ordinary skill in the art, given the benefit of this disclosure.

In accordance with certain examples, statistical and mathematical models may be used to validate the results using the variables for both the behavioral and econometric models at disease level. For example, for the behavioral models, a suitable predictive validation of multiattribute choice model may be found in V. Srinivasan and P. deMaCarty. “Predictive Validation of Multiattribute Choice Models.” Marketing Research, Winter 1999-Spring 2000, pp 29-32, the entire disclosure of which is hereby incorporated herein by reference for all purposes. For the econometric model at a disease level, additional models may be found, for example, in Huttin, C. Dis. Manage. Health Outcomes 2002, 10(5), pp. 1-9, the entire disclosure of which is hereby incorporated herein by reference for all purposes. In some examples, the software is selected for its ability to perform econometric analysis, e.g., Limdep, Stata and the like. Additional statistical software packages will be readily selected such as SPSS, which is commercially available from SPSS, Inc. (Chicago, Ill.), SAS, which is commercially available from the SAS Institute, Inc. (Cary, N.C.), STATA, which is commercially available from Stata Corp. LP (College Station, Tex.), or products from Sawtooth Software, Inc. (Sequim, Wash.). by the person of ordinary skill in the art, given the benefit of this disclosure. It will be within the ability of the person of ordinary skill in the art, given the benefit of this disclosure, to select suitable statistical models for use in the methods disclosed herein.

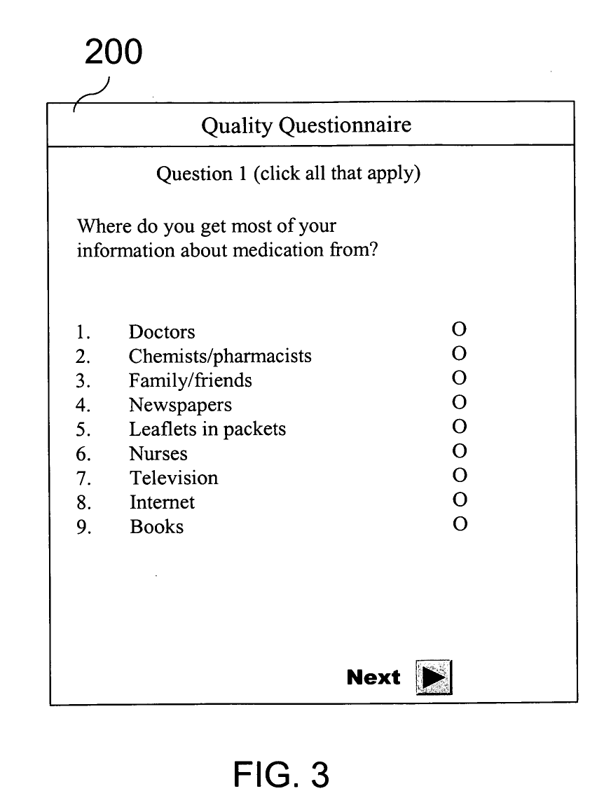

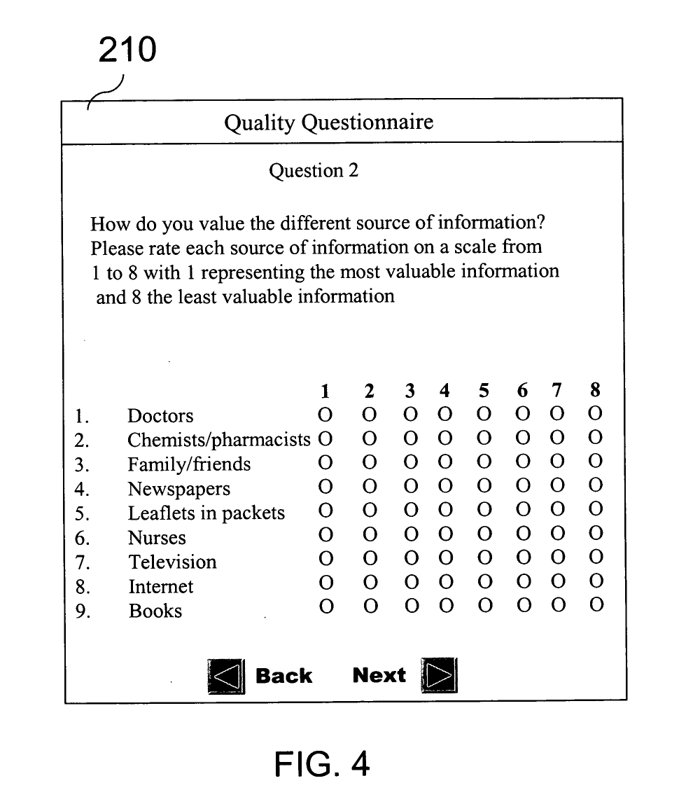

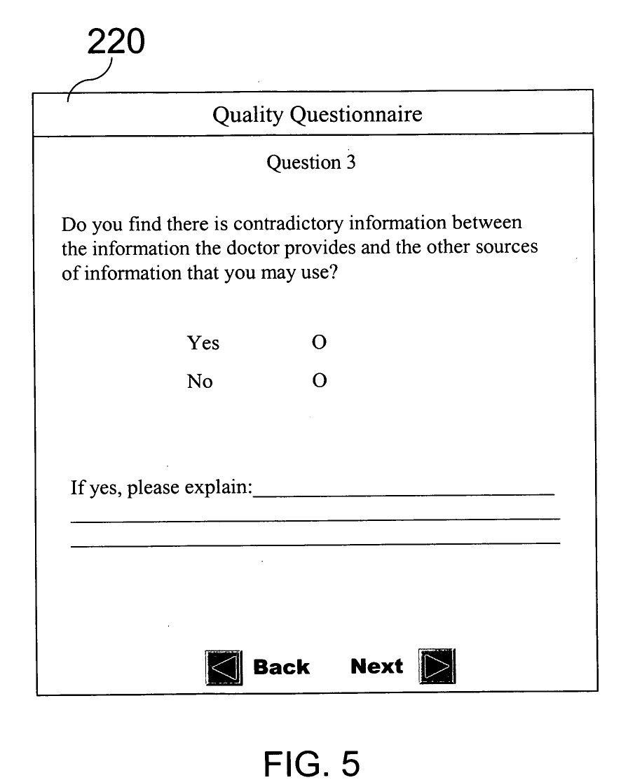

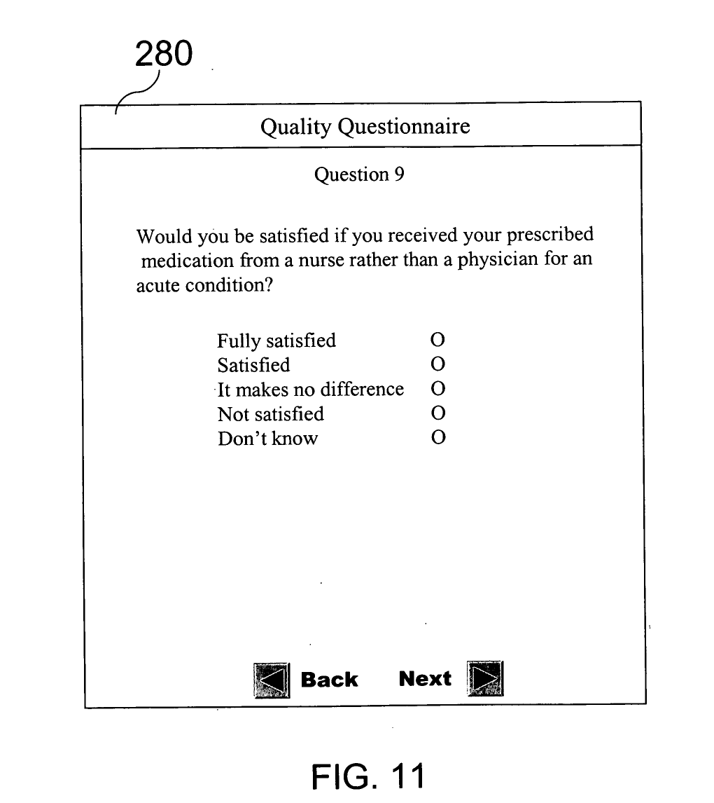

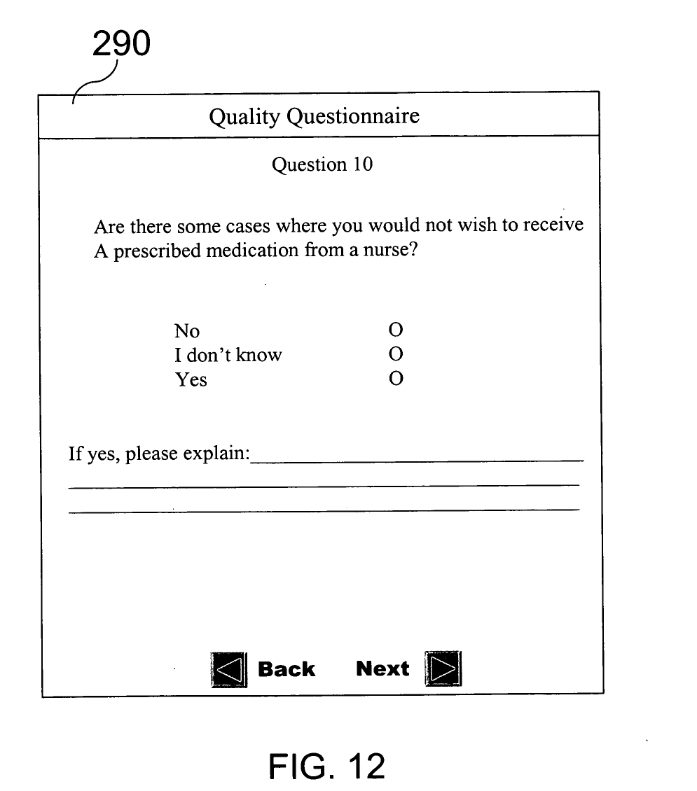

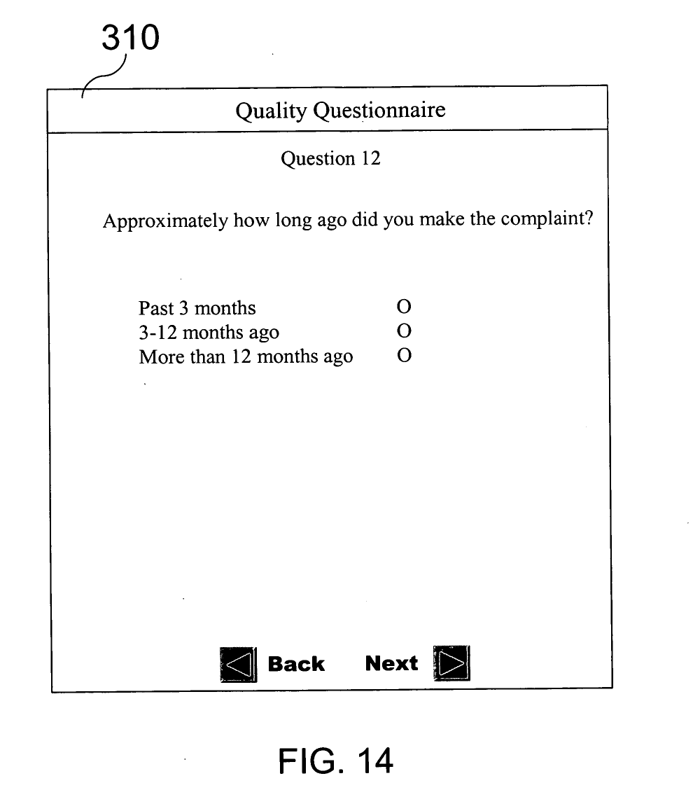

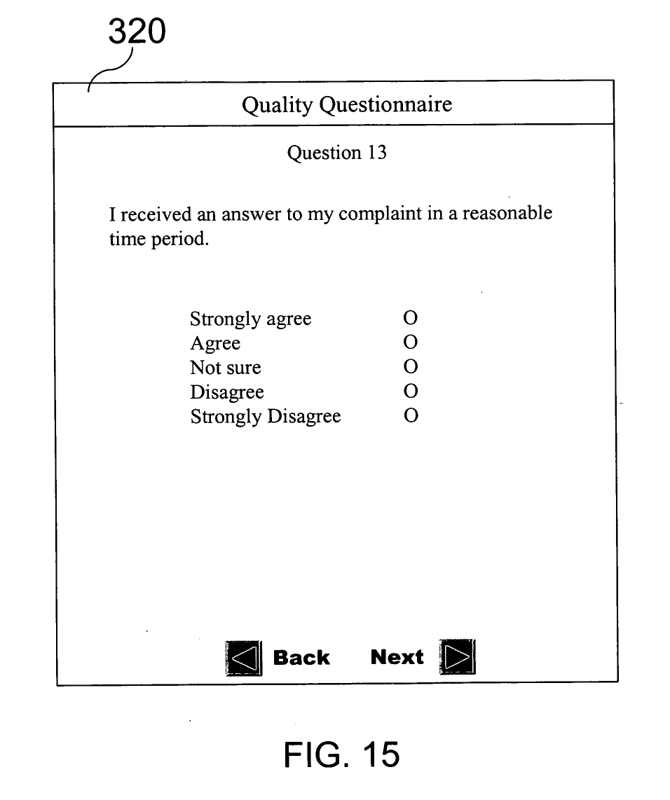

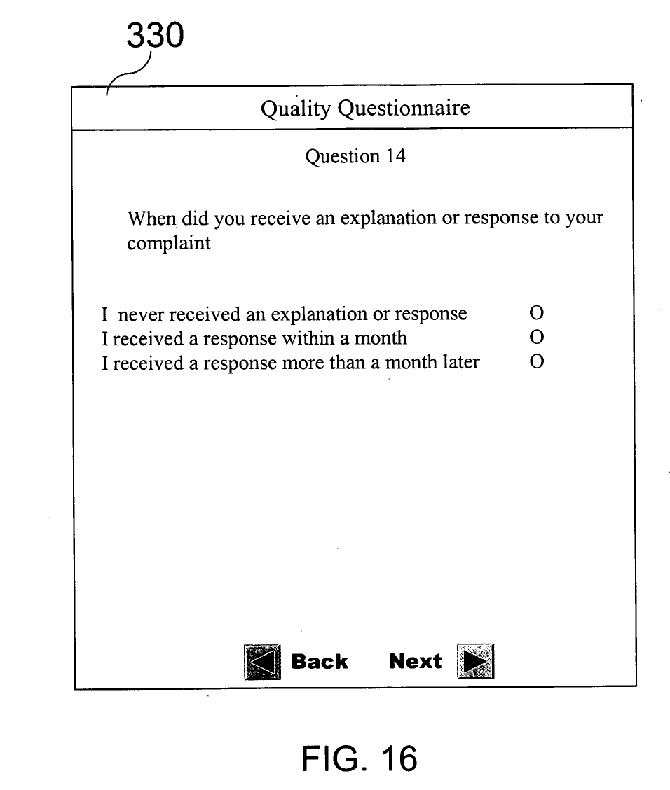

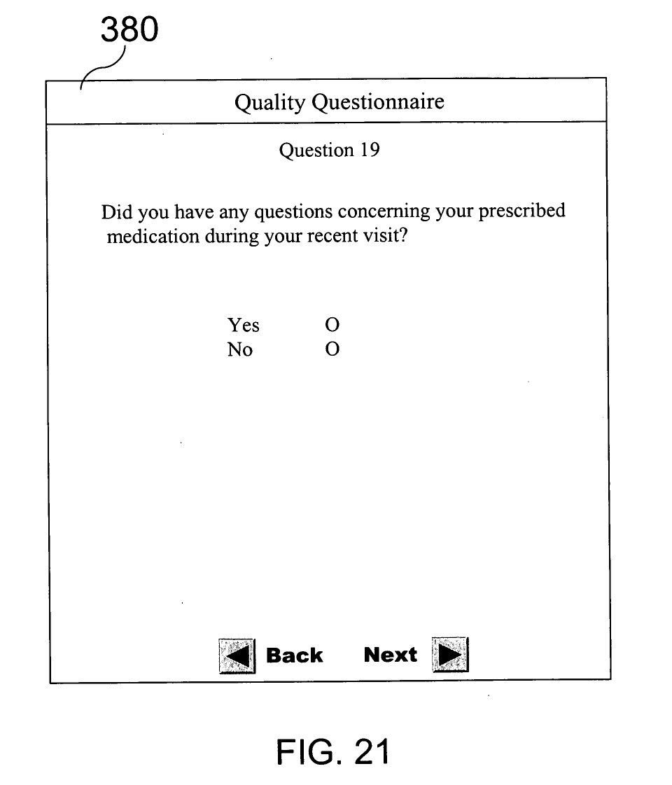

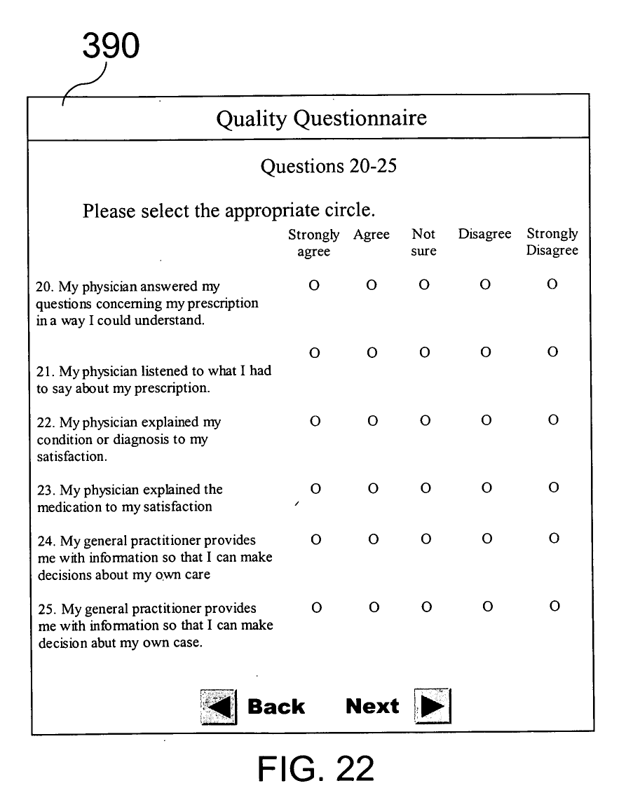

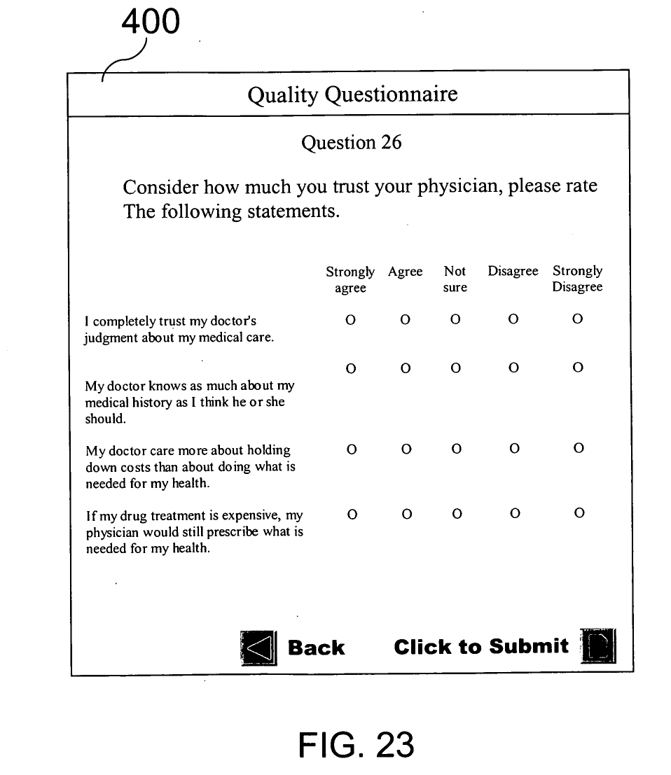

In accordance with certain examples, numerous methodologies, e.g., behavioral models, econometric model, etc., may be used to analyze the impact of variables. In some examples, the variables may be determined by qualitative research (e.g., focus groups, interviews, brainstorming exercises, etc.). In certain examples, qualitative research may be used to construct hypothetical cases that can be used to analyze physicians' preferences and to link the physicians' cost sensitivity analysis to prescribing intention shifts (intention data). Such data are then linked to effective prescribing or other treatment effective data. In other examples, the variables may be determined by interviewing of the patient, the patient by a physician or other health care practitioner, or the patient may be asked to fill out a questionnaire to self assess the patient cost variables. The questionnaire may take the form of a paper questionnaire, an electronic questionnaire, a telephonic questionnaire or other suitable method or device that allows assessment of patient cost variables. An exemplary electronic questionnaire that may be configured to assess quality or drug care variables for oral medications is shown in FIGS. 3-23.

Numerous drug quality indicators may be used, e.g., and illustrative indicators are described in FIGS. 3-23. Additional drug quality indicators are shown in Table 1b below.

TABLE 1b

| Information | Drug care | Access | Communication | Trust |
|---|---|---|---|---|
| Value of | Appropriateness | Access to | Answering the | Doctor's |
| information | of drug treatment | your GP | questions | judgement |
| from doctors | | whenever | | about patient |
| | | you think you | | medical care |
| | | need it | | |
| Value of | Skills of doctors | Arrangement | Listening | Doctor's |
| information | | for a GP to | | knowledge |
| from | | visit by phone | | about patient |
| chemists | | | | medical |
| | | | | history |
| Value of | Experience and | Waiting time | Explanation on | Doctor cares |
| information | training of | between | condition or | more about |
| from nurse | doctors | making an | diagnosis | holding cost |
| | | appointment and | | down than is |
| | | the day of the | | needed for the |
| | | visit | | patient's health |
| Value from | Skills of nurses | Length of | Explanation on | If the drug |
| media | | time spent | the cause to my | treatment is |
| | | waiting at | satisfaction | expensive, the |
| | | the practice | | GP would still |
| | | to see the GP | | prescribe what is |
| | | | | needed for |
| | | | | the patient's |
| | | | | health |
| | Experience and | Services available | Explanation of | |
| | training of nurses | for getting the | the medication | |
| | | prescription | | |
| | | either at the | | |
| | | surgery or at the | | |
| | | chemist | | |
| | | | GP provides | |
| | | | information so | |
| | | | that I can decide | |
| | | | on my own care | |

Patients may be asked a series of questions about their health care treatment, financial situation, cost preferences, risks, disease state, quality of care for medications and the like. The responses to these questions may be used to assess the value of the information, trust, communication, drug care quality, etc. Depending on the nature of the selected variables, e.g., cost variables versus quality variables versus risk variables, etc., the variables may be assigned a score, as illustrated below, to generate an index, such as, a cost sensitivity index, a quality index or a risk index. The cost sensitivity index can be compared to a lookup table to generate a treatment decision, a treatment decision shift or other selected outcomes. In some examples, assessment of such variables may lead to efficiency measures in primary care and use in non parametric models such as Data Envelopment Analysis (DEA).

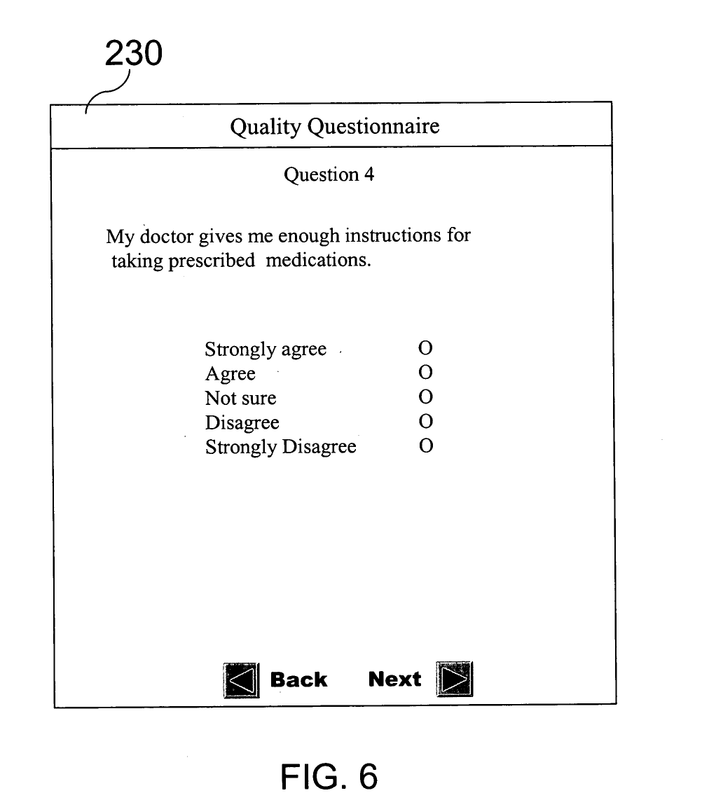

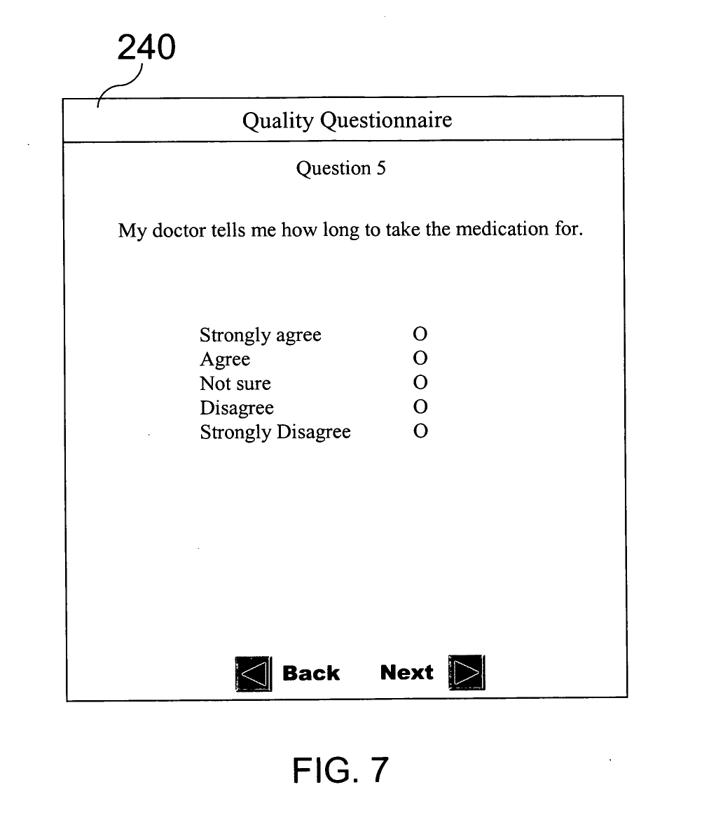

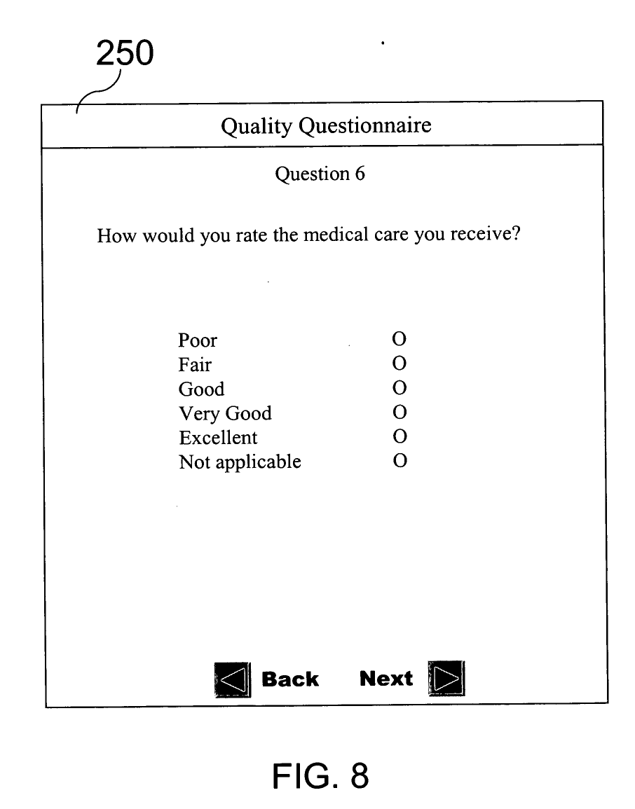

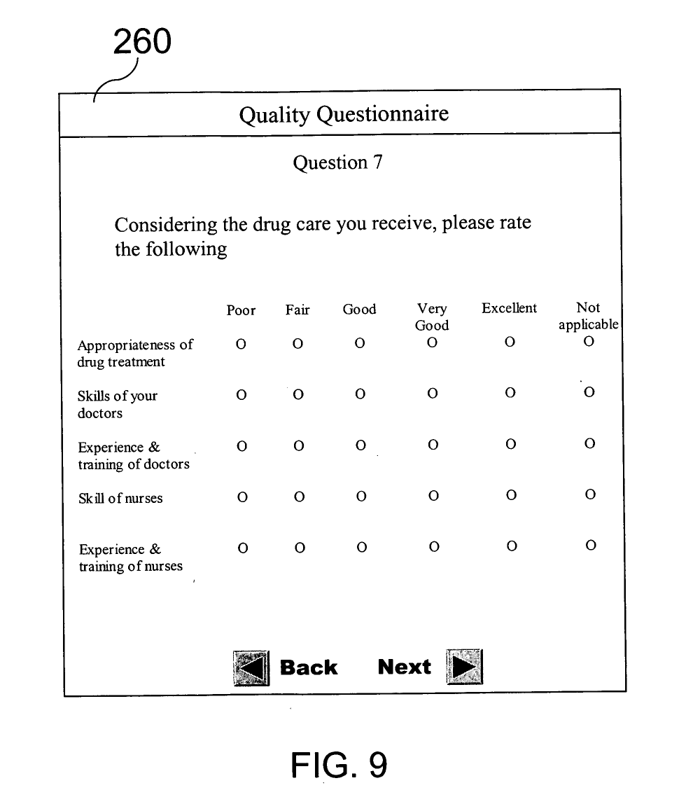

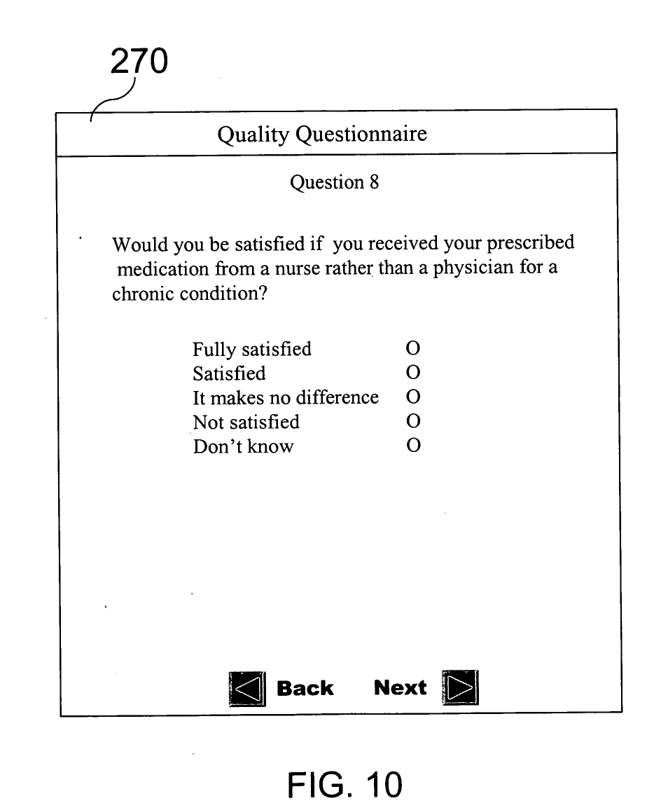

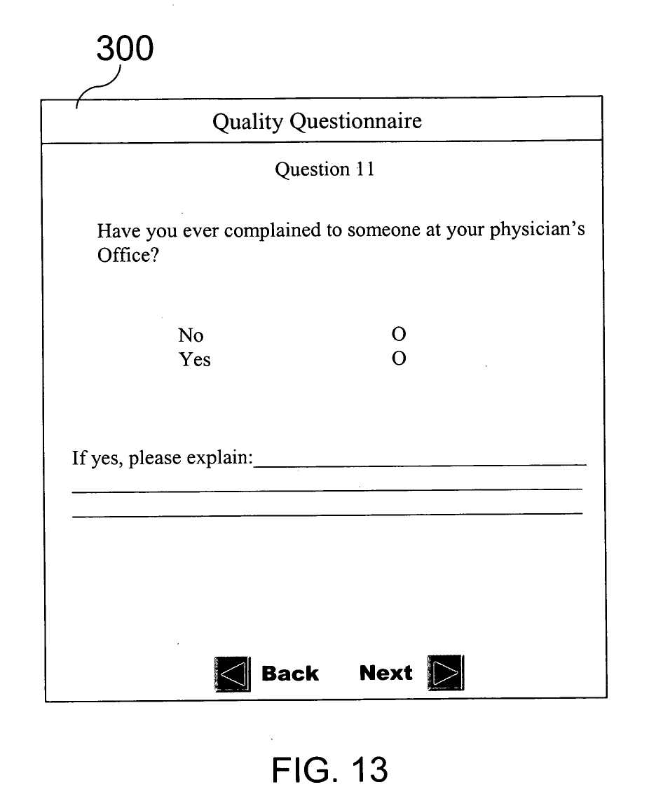

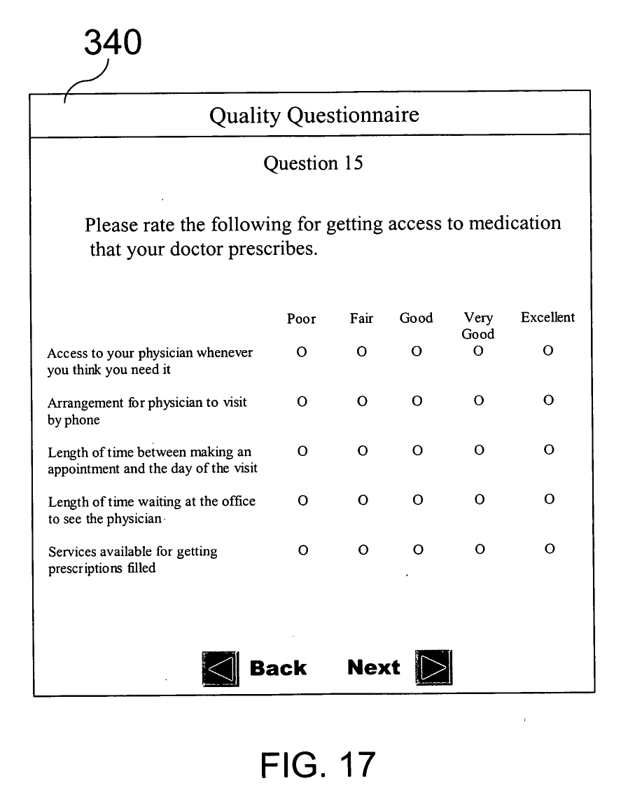

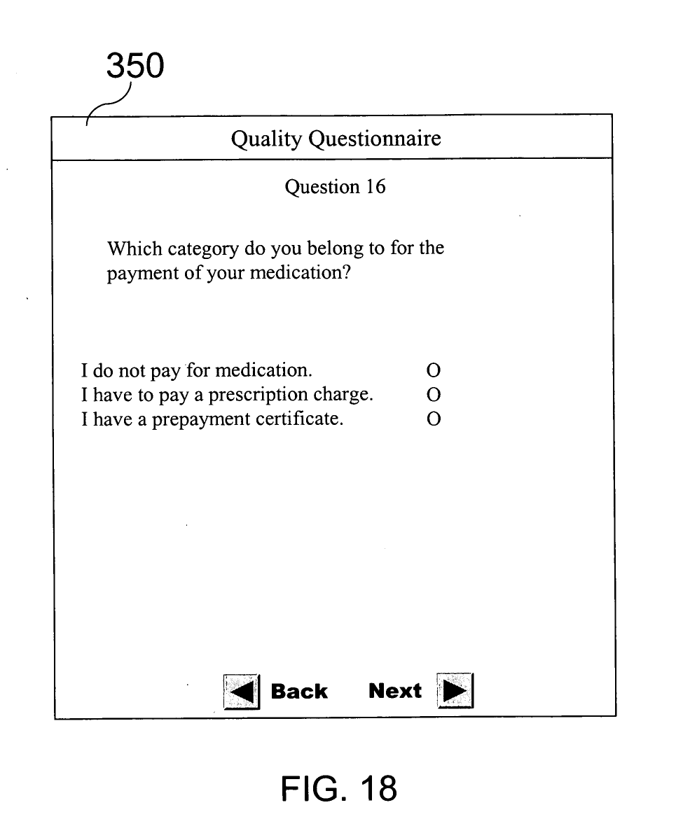

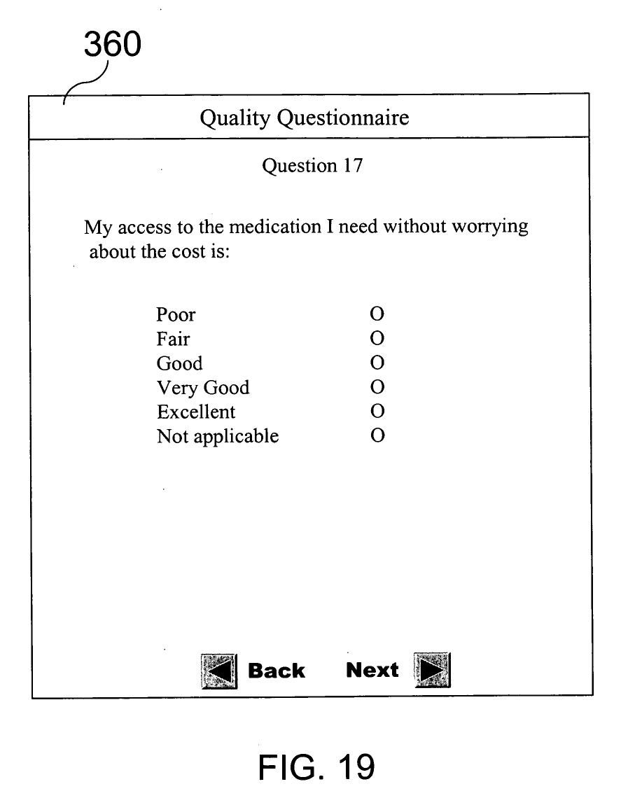

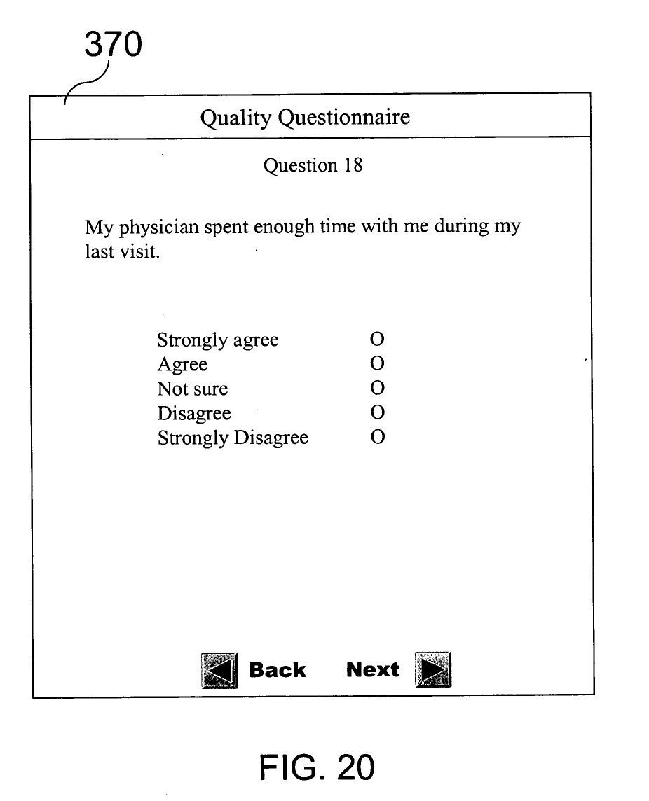

Referring now to FIGS. 3-5, forms 200, 210 and 220 may be used to inquire about the source of a patient's information. Marketing, advertising and the like may influence a patient's willingness to pay more or less for a certain health care decision. A patient's subjective belief in the reliability of such information may also influence a patient's willingness to pay more or less for a certain heath care decision, willingness to follow a prescribed decision or influence trust levels of their health care provider. Referring now to FIGS. 6-7, forms 230 and 240 may be used to assess a patient's understanding regarding prescribed medication or other suitable health care decision. If a patient is lacking information or has not received enough information, the patient may not follow a selected treatment protocol because of uncertainty or confusion in the treatment protocol. Referring now to FIGS. 8-9, forms 250 and 260 may be used to assess the quality of medical care and drug care received. If a patient believes that he or she is receiving poor quality of care, then that patient might be less motivated to pay more out-of-pocket expenses due to the dissatisfaction with the care. Referring now to FIGS. 10-12, forms 270, 280 and 290 may be used to determine a patient's preferences regarding the source of their health care, e.g., physician, nurse, pharmacist, etc. Because a patient may be able to omit the cost of a physician's office visit if the patient's care is provided by a pharmacist, the patient may be willing to pay more if their health care is provided by a pharmacist than by a physician. Referring now to FIGS. 13-16, forms 300, 310, 320 and 330 may be used to assess a patient's willingness to complain about poor health care. Referring now to FIG. 17, form 340 may be used to determine a patient's subjective views on their access to health care. If a patient views their health care as poor or inferior, the patient may be less willing to pay for expensive drugs. Referring now to FIGS. 18-19, forms 350 and 360 may be used to determine a patient's ability to pay for a medication based on the cost of the medication and the cost that the patient is responsible for paying. Forms 350 and 360 may be used to asses the patient's current economic situation taking into account available liquid cash, health insurance and the like. Referring to FIGS. 20-23, forms 370, 380, 390, and 400 may be used to assess the patient's satisfaction with their health care provider. As discussed above, if a patient is unsatisfied with their health care provider, they may be less willing to take the risk of paying large out of pocket expenses for a prescribed treatment or less willing to trust the prescribed treatment. Additional social and economic reasons that may affect a patient's responses to the forms shown in FIGS. 3-23 are possible and will be recognized by the person of ordinary skill in the art, given the benefit of this disclosure.

In accordance with certain examples, efficiency measures may be used. For example, the assessment of relative efficiency of practices (with focus on prescribing) may be analyzed. Weighted inputs and/or outputs may be used to take into account the quality and/or efficiency of prescribing. Quality measures as well as activity measures may be incorporated. The relative performance within practices and/or between practices. Efficiency measures may be analyzed by surveying a suitable population, scoring the results, optionally weighting the results and establishing a cost sensitivity index, a quality index, or an efficiency index based on the results from the survey. It will be within the ability of the person of ordinary skill in the art, given the benefit of this disclosure, to select suitable methods of accounting for efficiency measures.

In certain examples, a patient may select from a list of variables based on their economic situation. Each of the variables in the list can be scored and used to generate a treatment decision or treatment decision shift, as illustrated below. Alternatively, the list of variables may be ranked by the patient and the ranked order can be scored with higher rankings receiving a higher score to provide a cost sensitivity index that may be used to generate a treatment index or treatment decision shift.

In accordance with certain examples, a medical condition index may also be determined and used to generate a treatment decision. The medical condition index may be based on medical diagnosis of the patient by the physician. In some examples, the medical condition index and cost sensitivity index are provided equal weighting for generating a treatment decision or a treatment decision shift. Whereas, in other examples, a physician, or the person performing the method, may choose to weight the medical condition index more heavily than the patient variable condition index. In certain examples, a patient's subjective views on the severity of the disease or disorder are considered in determining the medical condition index. The patient's views regarding the severity of their condition may be assessed using a suitable questionnaire or may be inquired about by the physician during a medical work-up.

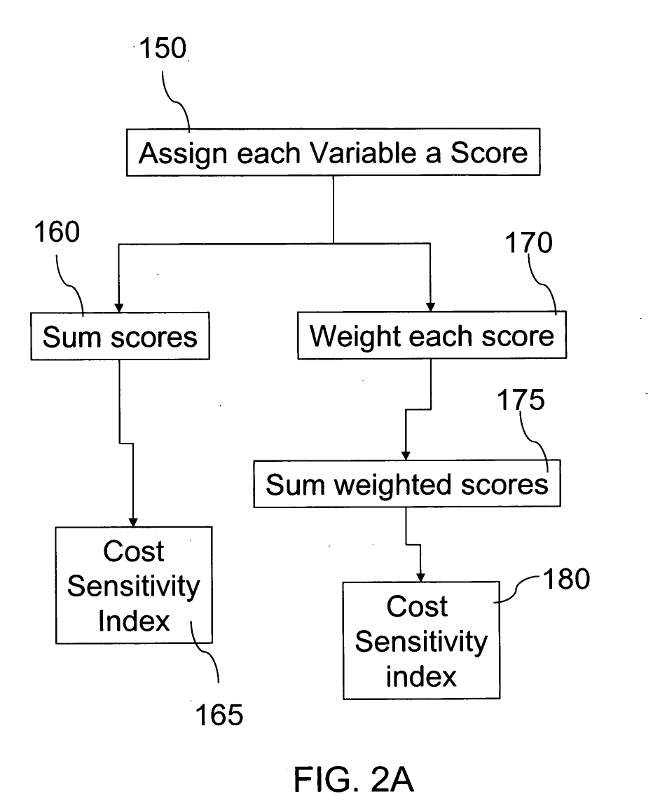

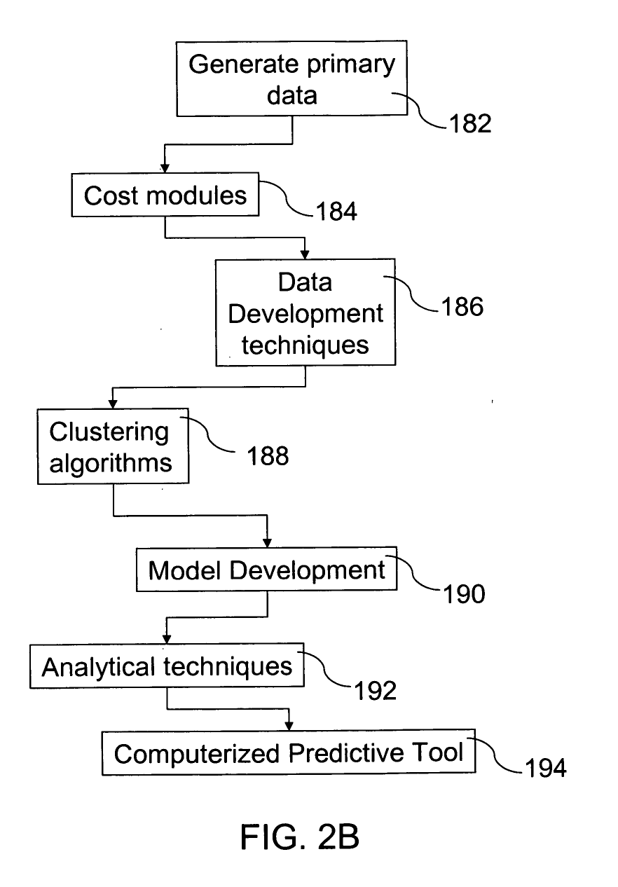

In certain examples, one or more variables may be used to generate a cost sensitivity index. As used herein, “cost sensitivity index” generally refers to an overall index of how costs, e.g., implicit costs, explicit costs, etc., affect a treatment decision shift or a treatment decision. In a typical implementation, one or more variables are listed in a questionnaire, and a user or group of users can select variables that are important to them or can rank the variables in the list. In certain examples, the variables may be ranked according to importance. In other examples, the variables may be assigned a score on a pre-selected scale, e.g., 0 to 10, and the various scores may be summed to provide a cost sensitivity index. An exemplary method of calculating a cost sensitivity index is described in FIG. 2. A user assigns a score 150 using a scale, e.g., 1-10, to a series of questions or statements that implement one or more variables. The assigned scores may be summed 160 to provide a cost sensitivity index 165. Alternatively, the assigned scores may be weighted 170 and the weighted scores can be summed 175 to provide a cost sensitivity index 180. For example, scores may be assigned on a 7 point scale, with 0 representing that the subject does not agree with the assessed variable and 7 being the subject strongly agrees with the assessed variable. These scored can be weighted and the weighted scores may be used in establishing a cost sensitivity index. For example, a weight may be associated with a selected cue as follows: 2 for patient demand, 1 for copayment for comedication, 0 for patient affordability and 0 for severity of the condition. Other suitable weightings are possible and will be readily selected by the person of ordinary skill in the art, given the benefit of this disclosure.

Numerous scoring strategies may be implemented for the different variables such that the scores assigned to the variables can be accounted for to provide a cost sensitivity index. In some examples, the scores are summed to provide a cost sensitivity index. In other examples, the scores are averaged to provide a cost sensitivity index. In yet other examples, one or more scores may be weighted and then the scores may be summed or averaged to provide a cost sensitivity index. Additional methods for accounting for the individual scores assigned to variables will be readily selected by the person of ordinary skill in the art, given the benefit of this disclosure.

In certain examples, a cost sensitivity index may be determined by ranking of variables by the patient. The variables can be weighted and summed to provide a cost sensitivity index. The selected weighting factors are typically chosen by the physician or health organization. Thus, the cost sensitivity index may depend in part on patient preferences and in part on physician preferences. Referring to Table 2 below, an example of variables that have been ranked by the physician are shown. The variables have been ranked according to how sensitive a physician is to three cost cues.

TABLE 2

| Variable | Ranking |
|---|---|
| Patient Copayment for Medication | 2 |
| Patient Affordability | 3 |
| Patient Demand for Cheaper Treatment | 1 |

In this ranking, patient demand may be ranked as most important to the physician copayment for medication was ranked second, and patient affordability for cheaper treatment was ranked third. To determine a cost sensitivity index, the rankings may be assigned the following pre-selected score: 100 for first ranking, 50 for second ranking and 25 for third ranking. For a given physician or health organization, the physician or health organization may select which of the variables he or she considers to be the most important and assign those variables a score.

In this series of prophetic examples, the physician may decide that patient affordability will be weighed most in his decision making and has selected the following weighting factors for the variables: 0.7 for patient affordability, 0.2 for patient demand for cheaper treatment, and 0.1 for patient copayment for medication. Using these values, a cost sensitivity index may be generated by multiplying the scores and weighting factors together and summing the values, as shown in Table 3.

TABLE 3

| Variable | Score | Weighting Factor | Weighted Score |
|---|---|---|---|
| Patient Copayment | 50 | 0.1 | 5 |
| for Comedication | | | |
| Patient Affordability | 100 | 0.7 | 70 |
| Patient Demand for | 25 | 0.2 | 5 |
| Cheaper Treatment | | | |

| | |
|---|---|
| Cost Sensitivity Index | 80 |

For comparison purposes, different cost sensitivity indices where the patient has altered the rankings of the three variables are shown below in Tables 4-8.

TABLE 4

| Variable | Rank | Score | Weighting Factor | Weighted Score |
|---|---|---|---|---|
| Patient Copayment | 1 | 100 | 0.1 | 10 |
| for Comedication | | | | |
| Patient Affordability | 2 | 50 | 0.7 | 3.5 |
| Patient Demand for | 3 | 25 | 0.2 | 5 |
| Cheaper Treatment | | | | |

| | |
|---|---|
| Cost Sensitivity Index | 18.5 |

TABLE 5

| Variable | Rank | Score | Weighting Factor | Weighted Score |
|---|---|---|---|---|
| Patient Copayment | 3 | 25 | 0.1 | 2.5 |
| for Comedication | | | | |
| Patient Affordability | 2 | 50 | 0.7 | 3.5 |
| Patient Demand for | 1 | 100 | 0.2 | 20 |
| Cheaper Treatment | | | | |

| | |
|---|---|
| Cost Sensitivity Index | 26 |

TABLE 6

| Variable | Rank | Score | Weighting Factor | Weighted Score |
|---|---|---|---|---|
| Patient Copayment | 2 | 50 | 0.1 | 5 |
| for Comedication | | | | |
| Patient Affordability | 3 | 25 | 0.7 | 17.5 |
| Patient Demand for | 1 | 100 | 0.2 | 20 |
| Cheaper Treatment | | | | |

| | |
|---|---|
| Cost Sensitivity Index | 42.5 |

TABLE 7

| Variable | Rank | Score | Weighting Factor | Weighted Score |
|---|---|---|---|---|
| Patient Copayment | 1 | 100 | 0.1 | 10 |
| for Comedication | | | | |
| Patient Affordability | 3 | 25 | 0.7 | 17.5 |
| Patient Demand for | 2 | 50 | 0.2 | 10 |
| Cheaper Treatment | | | | |

| | |
|---|---|
| Cost Sensitivity Index | 37.5 |

TABLE 8

| Variable | Rank | Score | Weighting Factor | Weighted Score |
|---|---|---|---|---|
| Patient Copayment | 3 | 25 | 0.1 | 2.5 |
| for Comedication | | | | |
| Patient Affordability | 1 | 100 | 0.7 | 70 |
| Patient Demand for | 2 | 50 | 0.2 | 10 |
| Cheaper Treatment | | | | |

| | |
|---|---|
| Cost Sensitivity Index | 82.5 |

In this model, the cost sensitivity index is significantly higher when the patient ranks the patient affordability variable first and drops significantly when the patient affordability variable is ranked second or third.

In certain examples, a treatment decision shift can be generated by correlating the cost sensitivity index with a lookup table to output a list of treatment decision shifts. A treatment decision shift generally refers to changes in drug prescribing attitudes or selected medical treatments. Typically, a treatment decision shift can be c

For example, a hierarchy may be arranged where the cost sensitivity index is inversely proportional to the treatment cost to predict if a shift in treatment will or has occurred. The values in the lookup table can be selected by the physician or other health organization. An exemplary lookup table is shown below in Table 9.

TABLE 9

| Cost Sensitivity Index | Treatment Decision Shift |
|---|---|
| 0 to 20 | Prescribe drug or treatment without |
| | considering cost to patient. |
| 21 to 60 | Prescribe drug or treatment considering cost |
| | to patient. |
| 61 to 100 | Prescribe drug or treatment to minimize cost |
| | to patient. |

In certain examples, a treatment decision can be generated by correlating the cost sensitivity index with a lookup table to output a list of potential treatment options. For example, a hierarchy may be arranged where the cost sensitivity index is inversely proportional to the price of a prescribed drug. This example accounts for both the patient's subjective views on costs as well as the physician's subjective views on costs. The values in the lookup table can be selected by the physician or other health organization. An exemplary lookup table is shown below in Table 10.

TABLE 10

| Cost Sensitivity Index | Treatment Decision |
|---|---|
| 0 to 20 | Prescribe drug having copay >$35 |
| 21 to 60 | Prescribe drug having copay between $10 |
| | and $35 |
| 61 to 100 | Prescribe drug having copay <$10 |

The treatment decision from the lookup table can be outputted to a suitable display or device so that the physician can base his or her medical treatment of a patient on the treatment decision. In some examples, only a single value for the treatment decision is returned to the display, whereas in other examples, two or more values for the treatment decision are returned to provide a physician with a choice of treatments.

In certain examples, an additional lookup table may be used to determine which drugs fall within a treatment decision. For example, if a patient is presenting symptoms for hypertension, then the following table (Table 1) might be used to determine which drug or drugs to prescribe for the patient.

TABLE 11

| Treatment Decision | Drug |
|---|---|
| Prescribe drug having copy <$35 | Beta blocker 1 |
| | Acetylcholinesterase Inhibitor 1 |
| Prescribe drug having copay between | Beta blocker 2 |
| $10 and $35 | Diuretic 1 |
| Prescribe drug having copay <$10 | Diuretic 2 |
| | Calcium channel blocker 1 |

The drug listings from the table may be returned to the physician to assist the physician in prescribing a drug that meets the cost concerns of the patient and that will provide effective medical care to the patient. The person of ordinary skill in the art, given the benefit of this disclosure, will be able to design suitable lookup tables for guiding health care decisions. By using treatment decisions and treatment decision shifts, drugs and health care decision can be selected to provide cost effective treatment to a patient that a patient is likely to follow, whereas existing methods may select treatments that a patient will not or cannot follow because the patient cannot afford the treatment.

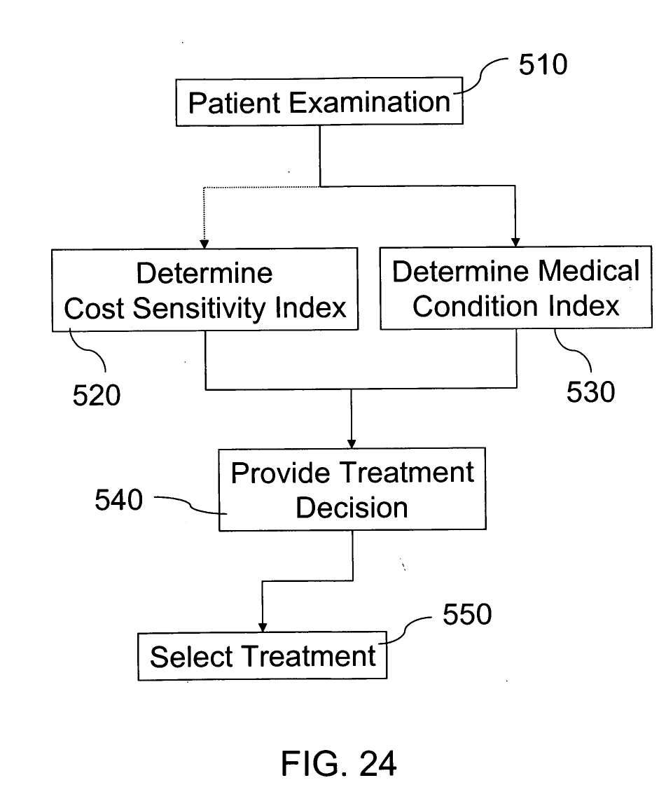

Referring to FIG. 24, an example of a method that accounts for both the patient cost index and the medical condition index may be provided. A patient examination 510 may be conducted by a physician or other health practitioner. The physician typically will question the patient about their health, symptoms, pain and the like. The physician may also order one or more medical tests to assist in diagnosis of the patient. Based on the physician's examination and any medical tests, the physician may determine a medical condition index 530, which reflects the patient's current state of health. For example, the medical condition index may be determined by assigning the various test results a score or can be selected by the physician based on severity of the disease or disorder. The physician may also use the cost sensitivity index 520, if such index has previously been determined. Alternatively and as shown as a dotted line in FIG. 24, the physician may question the patient about variables to determine the cost sensitivity index. Using the cost sensitivity index and the medical condition index, a treatment index 540 can be generated. The treatment decision 540 provides a number of health care decisions, e.g., treatment protocols, that may be evaluated to aid the physician in selecting the proper treatment for the patient. Once the proper treatment is determined, the physician may then select that treatment and prescribe suitable drugs or order suitable medical procedures for the patient. This method provides numerous advantages because it reflects both the ability of the patient to pay for the selected treatment as well as the physician's observations and diagnosis of the patient's disease or disorder. The method can be tailored to each patient according to the cost sensitivity index used for that particular patient and can be altered should the cost sensitivity index change, e.g., due to change in employment circumstances or change in health care insurance.

In certain examples, multiple cost variables, e.g., cost modules, may be considered where some of the variables are based on physician practices and information and other variables are based on patient psychological and/or socioeconomic information. Certain examples may also consider physician cost variables, e.g., transaction costs, reimbursement amounts and the like. For example, the cost sensitivity decision tool may account for the pathways physicians receive information on drugs, drug prices and/or patient socioeconomic information. Using these variables, a treatment decision can be obtained for a selected patient to determine suitable treatment regimens, e.g., suitable medical procedures and/or suitable prescription or over the counter drugs.

In accordance with certain examples, a quality index may be generated based on user responses to a list of variables. In examples where a quality index is desired, the variables are typically selected to identify issues relevant to the quality of health care received by a patient. The variables may be assigned a score or rank, the score or ranks may optionally be weighted and a quality index may be determined by summing the scores. The quality index may be compared to a lookup table to generate a treatment decision shift or a treatment index, as described elsewhere herein. The person of ordinary skill in the art, given the benefit of this disclosure, will be able to select suitable methods for generating quality indices.

In accordance with certain examples, the variables may be used to assess or determine a risk index. For example, decreases in health care budgets can result in increased risk to patients. Physicians may be forced to spend less time with each patient to increase their workload to offset budgetary pressures. Patients having severe diseases or disorders are especially at risk. Using the methods disclosed herein, a risk index can be determined and used to generate a treatment index or a treatment decision shift. The risk index is typically based on user responses to risk variables, such as severity of disease, severity of symptoms and the like. Risk may be ranked according to various levels, such as very high risk taker, high risk taker and low risk taker. Such rankings may be assessed based on the number of questions that a user responds to, e.g., the number of questions the user agrees with. In some examples, risk perception is assessed. Risk perception may include, but is not limited to, risk attitudes, health beliefs, disease severity, disease symptoms and the like. Risk and risk perception may be assessed by surveying of patients, health care providers, or both. It will be within the ability of the person of ordinary skill in the art, given the benefit of this disclosure, to determine suitable risk indices for use in selecting treatment decisions.

In accordance with certain examples, the methods disclosed herein may be used to assess the market for a new drug. Typically one or more variables will be selected based on market factors, such as drug price, effectiveness of drug treatment, amount of copay required by an insurance company and the like. For example, a pharmaceutical company may survey physicians, patients or both, to assess whether or not a physician would prescribe the new drug and/or the patient would be willing to take the new drug and/or pay for the new drug. A cost sensitivity index can be created and compared with cost sensitivity indices for existing drugs to determine whether or not the new drug should be pursued. The cost sensitivity indices may be calculated using the illustrative methods disclosed herein, e.g., surveying a group, assigning the results a score, optionally weighting the scores and summing the scores to establish an index. Other suitable methods of establishing cost sensitivity indices will be readily selected by the person of ordinary skill in the art, given the benefit of this disclosure.

In accordance with certain examples, methods and computer systems for providing evidence and related information, analysis, outcome and other performance measures to policymakers on health care budgets may be implemented. In certain examples and referring to FIG. 2B, primary data may be generated 182, e.g., from the development of behavioral methods. The data may be stored in banks, such as cost modules 184. Data development techniques 186 may be used match data from various data sets. One or more clustering algorithms 188 may be used to aggregate and/or disaggregate the data. Models may be developed 190 to account for econometrics and to link the behavioral models with the econometric models, using, for example, suitable analytical techniques 192. A computerized predictive tool 192 may then be developed to assess expenditures, health status, outcomes, costs and the like.

In accordance with certain examples, various embodiments of the technology described herein may be implemented on one or more computer systems. These computer systems may be, for example, general-purpose computers such as those based on Unix, Intel PENTIUM-type processor, Motorola PowerPC, Sun UltraSPARC, Hewlett-Packard PA-RISC processors, or any other type of processor. It should be appreciated that one or more of any type computer system may be used according to various embodiments of the technology. Further, the system may be located on a single computer or may be distributed among a plurality of computers attached by a communications network. A general-purpose computer system according to one embodiment may be configured to perform any of the described functions including but not limited to: variable input, user inputs, outputting of cost sensitivity indices, quality indices, risk indices, treatment decision shift, treatment decision and the like. It should be appreciated that the system may perform other functions, including network communication, and the technology is not limited to having any particular function or set of functions.

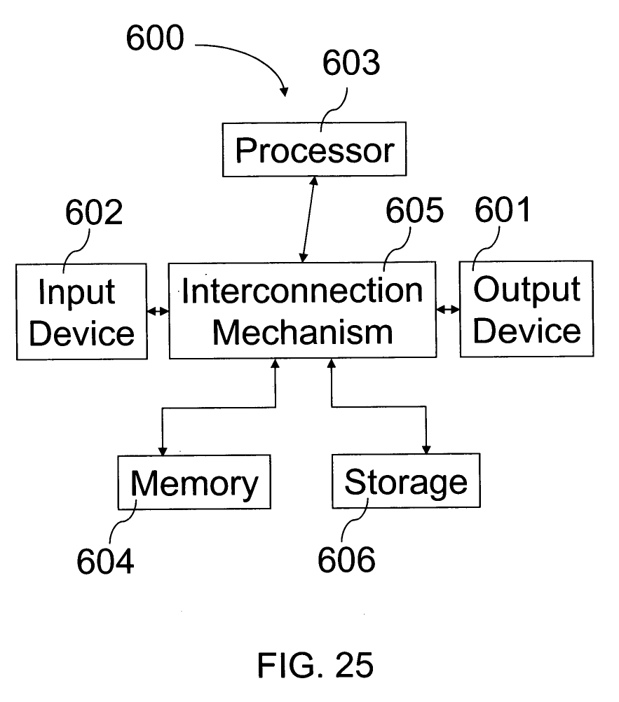

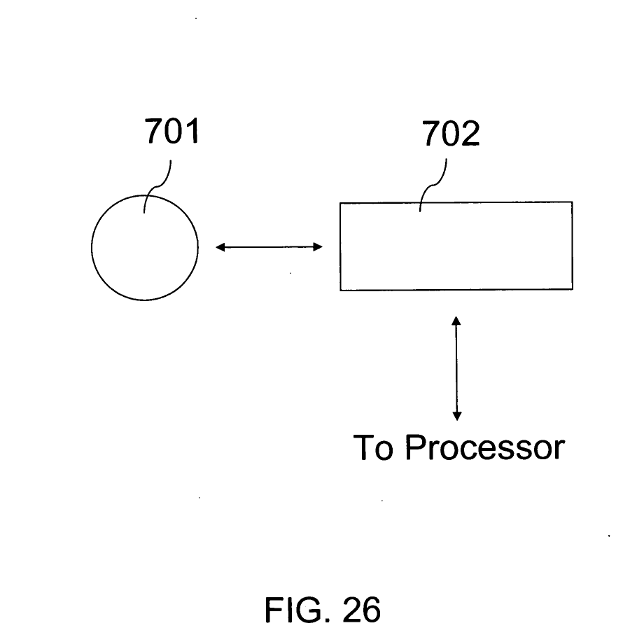

For example, various aspects may be implemented as specialized software executing in a general-purpose computer system 600 such as that shown in FIG. 25. The computer system 600 may include a processor 603 connected to one or more memory devices 604, such as a disk drive, memory, or other device for storing data. Memory 604 is typically used for storing programs and data during operation of the computer system 600. Components of computer system 600 may be coupled by an interconnection mechanism 605, which may include one or more busses (e.g., between components that are integrated within a same machine) and/or a network (e.g., between components that reside on separate discrete machines). The interconnection mechanism 605 enables communications (e.g., data, instructions) to be exchanged between system components of system 600.

Computer system 600 also includes one or more input devices 602, for example, a keyboard, mouse, trackball, microphone, touch screen, and one or more output devices 601, for example, a printing device, display screen, speaker. In addition, computer system 600 may contain one or more interfaces (not shown) that connect computer system 600 to a communication network (in addition or as an alternative to the interconnection mechanism 605.

The storage system 606, shown in greater detail in FIG., 26, typically includes a computer readable and writeable nonvolatile recording medium 701 in which signals are stored that define a program to be executed by the processor or information stored on or in the medium 701 to be processed by the program. The medium may, for example, be a disk or flash memory. Typically, in operation, the processor causes data to be read from the nonvolatile recording medium 701 into another memory 702 that allows for faster access to the information by the processor than does the medium 701. This memory 702 is typically a volatile, random access memory such as a dynamic random access memory (DRAM) or static memory (SRAM). It may be located in storage system 606, as shown, or in memory system 604, not shown. The processor 603 generally manipulates the data within the integrated circuit memory 604, 702 and then copies the data to the medium 701 after processing is completed. A variety of mechanisms are known for managing data movement between the medium 701 and the integrated circuit memory element 604, 702, and the invention is not limited thereto. The technology is not limited to a particular memory system 604 or storage system 606.

The computer system may also include specially-programmed, special-purpose hardware, for example, an application-specific integrated circuit (ASIC). Aspects of the technology may be implemented in software, hardware or firmware, or any combination thereof. Further, such methods, acts, systems, system elements and components thereof may be implemented as part of the computer system described above or as an independent component.

Although computer system 600 is shown by way of example as one type of computer system upon which various aspects of the technology may be practiced, it should be appreciated that aspects are not limited to being implemented on the computer system as shown in FIGS. 25. Various aspects may be practiced on one or more computers having a different architecture or components than that shown in FIG. 25. Computer system 600 may be a general-purpose computer system that is programmable using a high-level computer programming language. Computer system 600 may be also implemented using specially programmed, special purpose hardware. In computer system 600, processor 603 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME) or Windows XP operating systems available from the Microsoft Corporation, MAC OS System X operating system available from Apple Computer, the Solaris operating system available from Sun Microsystems, or UNIX or Linux operating systems available from various sources. Many other operating systems may be used.

The processor and operating system together define a computer platform for which application programs in high-level programming languages are written. It should be understood that the technology is not limited to a particular computer system platform, processor, operating system, or network. Also, it should be apparent to those skilled in the art that the present technology is not limited to a specific programming language or computer system. Further, it should be appreciated that other appropriate programming languages and other appropriate computer systems could also be used.

In certain examples, the hardware of software is configured to implement cognitive architecture, neural networks or other suitable implementations. For example, a medical informatics gateway may be linked with a medical informatics broker and/or a medical informatics repository to provide access to data or survey results. Such configuration would allow for storage and access of large sampled populations, which can increase the validity of the predictive tool.

One or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. Patients and physicians may use different networks and the variables can be linked using suitable network protocols. For example, various aspects may be performed on a client-server or multi-tier system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP). It should also be appreciated that the technology is not limited to executing on any particular system or group of systems. Also, it should be appreciated that the technology is not limited to any particular distributed architecture, network, or communication protocol.

Various embodiments may be programmed using an object-oriented programming language, such as SmallTalk, Basic, Java, C++, Ada, or C# (C-Sharp). Other object-oriented programming languages may also be used. Alternatively, functional, scripting, and/or logical programming languages may be used. Various aspects may be implemented in a non-programmed environment (e.g., documents created in HTML, XML or other format that, when viewed in a window of a browser program, render aspects of a graphical-user interface (GUI) or perform other functions). Various aspects may be implemented as programmed or non-programmed elements, or any combination thereof.

Certain specific examples are described in more detail below to illustrate further certain features and aspects of the technology (physicians' cost sensitivity analysis, prescribing intentions' shifts,

### EXAMPLE 1

### Cost Sensitivity Analysis of Physicians

A conjoint design for hay fever was performed using the following 11 patient cost variables listed in Table 12 below.

TABLE 12

| Patient cost cue | Levels | Description of the level |
|---|---|---|
| Patient | Level 1 | The patient has a low income, he is without |
| affordability | | additional insurance (1) and has to advance |
| | | the cash payment (consultation and |
| | | medications) (2) |
| | Level 2 | The patient has a low income, he has an |
| | | additional insurance and has to advance the |
| | | cash payment (consultation and |
| | | medications) |
| | Level 3 | The patient has a good income, he has an |
| | | additional insurance and has to advance the |
| | | cash payment |
| | | (consultation and medications) |
| Patient demand | Level 4 | The patient does not demand cheaper |
| for cheaper | | medication |
| medication | | |
| | Level 5 | The patient demand cheaper medication |
| Severity cue | Level 6 | The patient sneezes and sniffs, certain days |
| | | when the pollen rate is high |
| | Level 7 | The patient sneezes and sniffs, during the |
| | | all hay fever season |
| | Level 8 | The patient sneezes, sniffs and has eye |
| | | problem during the all hay fever season, he |
| | | says he is considerably bothered in his daily |
| | | life |
| Co-payment for | Level 9 | The patient has no other condition, for |
| comedication | | which he has other medications. |
| cue (1) | | |
| | Level 10 | The patient is an asthmatic patient without |
| | | complications and well balanced by a |
| | | treatment “de fond”; he must contribute for |
| | | his co-payment for an amount of 10 euros. |
| | Level 11 | The patient is an asthmatic patient without |
| | | complications and well balanced by a |
| | | treatment “de fond”; he must contribute for |
| | | his co-payment for an amount of around |
| | | 30euros. |

The results of the cost sensitivity analysis for hay fever are shown below in Table 13. The results of the cost sensitivity analysis estimated the average utility values for physicians to determine which cues were significant. A clustering analysis was performed using SPSS (maximum set at four clusters) based on the Euclidean distance to identify cost sensitive physicians. A first analysis was performed by Skim analytical (Netherlands). The data was collected with Conjoint CVA software and was transferred for analysis in to the standard SPSS package. The clustering method that was used is available in the standard SPSS package and uses a priori a limit of four clusters. In this case the Euclidean distance was chosen, but other distances, e.g., Mahalanobis distance, might improve the clustering results.

TABLE 13

| | | | | Mean | |
|---|---|---|---|---|---|
| | | | | (utility | Standard |
| | N | Minimum | Maximum | value) | deviation |
| Patient afford | 101 | | | | |
| Cue level 1 | 101 | −0.85 | 0.00 | −0.0526 | 0.13502 |
| Cue level 2 | 101 | −0.13 | 0.42 | 0.0136 | 0.07059 |
| Cue level 3 | 101 | 0.00 | 0.44 | 0.0390 | 0.07985 |
| Patient demand | 101 | | | | |
| Cue level 4 | 101 | −1.58 | 0.00 | −0.2455 | 0.34205 |
| Cue level 5 | 101 | 0.00 | 1.58 | 0.2455 | 0.34205 |
| Disease | 101 | | | | |
| severity | | | | | |
| Cue level 6 | | −0.51 | 0.89 | 0.0560 | 0.29249 |
| Cue level 7 | | −0.95 | 0.61 | −0.0388 | 0.23767 |
| Cue level 8 | | −1.08 | 0.55 | −0.0172 | 0.28959 |
| Copay/comedic | 101 | | | | |
| Cue level 9 | 101 | −1.15 | 0.00 | −0.1479 | 0.21720 |
| Cue level 10 | 101 | −0.54 | 0.54 | −0.0153 | 0.12104 |
| Cue level 11 | 101 | 0.00 | 1.27 | 0.1632 | 0.24855 |
| Valid cases | 101 | | | | |

A variance analysis for the hay fever study was performed. The variance analysis results are shown below in Table 14.

TABLE 14

| | F | Significativity |
|---|---|---|
| Patient affordability cue | | |
| Cue level 1 | 1.002 | 0.319 |
| Cue level 2 | 1.698 | 0.196 |
| Cue level 3 | 0.295 | 0.588 |
| Patient demand cue | | |
| Cue level 4 | 205.804 | 0.000 |
| Cue level 5 | 205.804 | 0.000 |
| Severity cue | | |
| Cue level 6 | 1.814 | 0.181 |
| Cue level 7 | 2.804 | 0.097 |
| Cue level 8 | 7.890 | 0.006 |
| Co-payment for | | |
| comedications | | |
| Cue level 9 | 31.782 | 0.000 |
| Cue level 10 | 0.002 | 0.967 |
| Cue level 11 | 22.302 | 0.000 |

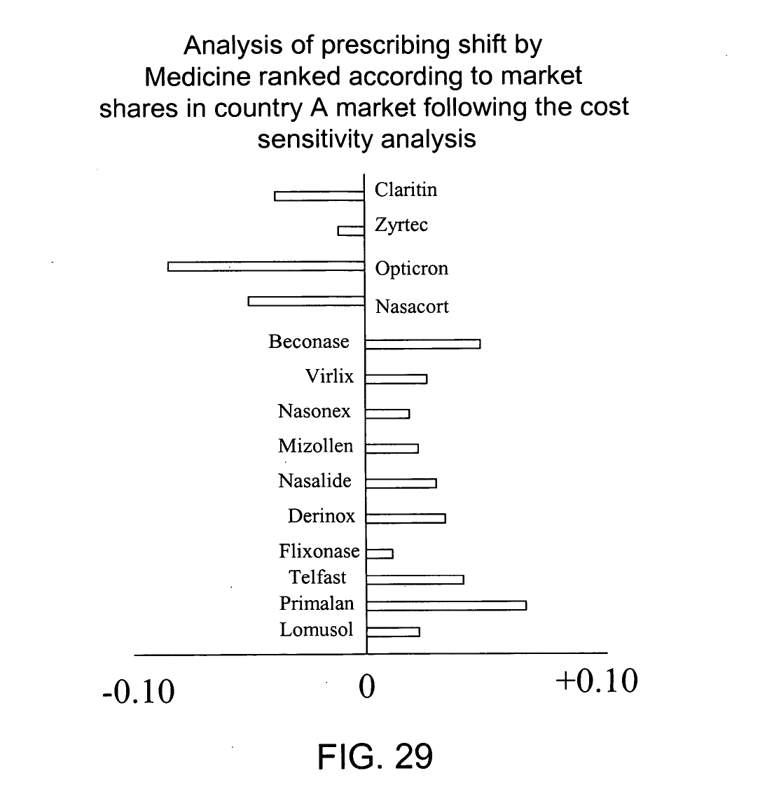

The results above were consistent with patient affordability and copayment for comedication being the most significant patient cost variables in the. The prescribing intention shifts in the case of the study are shown in FIG. 29. Positive values indicate a physician is more likely to prescribe the drug, whereas negative values indicate the physician is less likely to prescribe the drug.

### EXAMPLE 2

### Physician Prescribing Intention Shifts

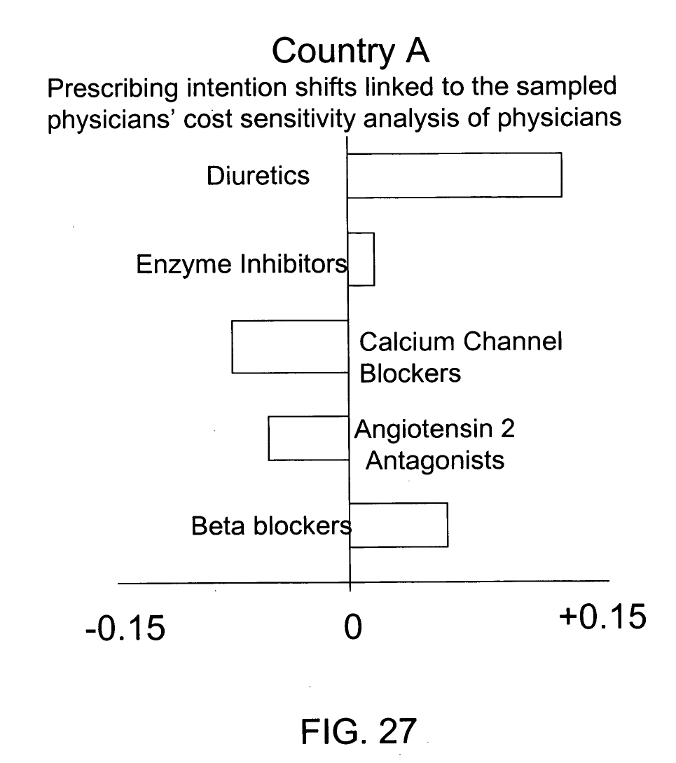

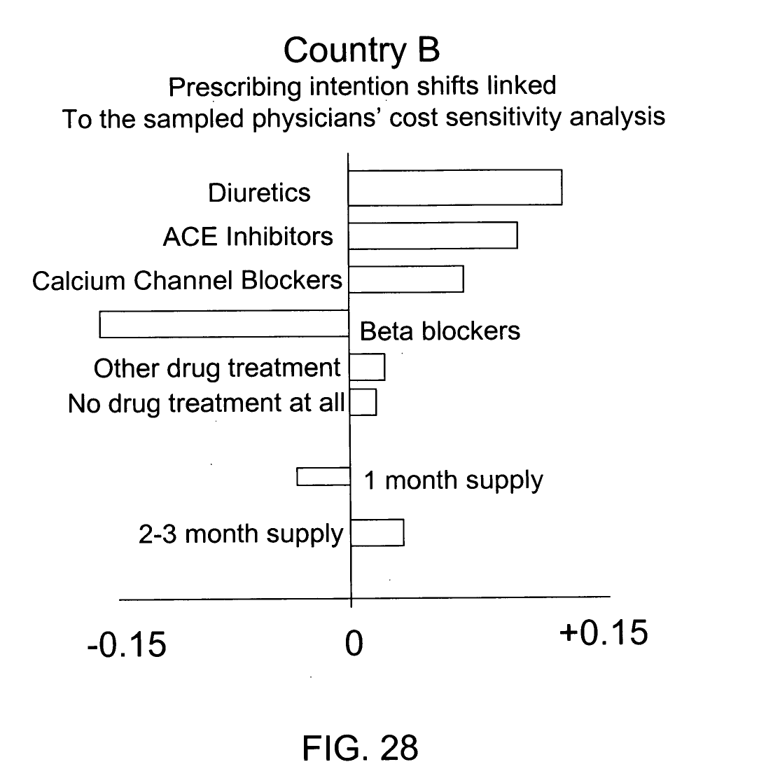

Prescribing practices of physicians may be determined according to the prevalence a physician prescribes a certain drug (or class or drugs) for a selected disorder. It is useful to determine the prescribing intention shifts to assess whether or not physicians are taking patient costs into account. FIGS. 27 and 28 show the prescribing intention shifts for two countries (Country A and Country B, respectively) for treating hypertension. The data used to construct the graphs was taken at the physician's office, i.e., physician point of visit. Values that are positive indicate that the drug is more likely to be prescribed, whereas values that are negative indicate that the drug is less likely to be prescribed by a physician. It was found that one prevalent method used to minimize costs was to prescribe a longer supply of a given drug (2-3 month supply versus 1 month supply) rather than supply a cheaper drug. That is, physicians preferred to supply more of a drug rather than supply a cheaper drug.

### EXAMPLE 3

### Effective Prescribing Pattern and Type of Insurance (Diabetic, Hypertensive and Asthmatic Patients)

Data was extracted for two samples of individuals from the 1996 National Ambulatory Survey. The data that was used was taken from point of visit data, e.g., data taken during the physician visit.

The hypertension samples consisted of 1844 patients, and the diabetic sample consisted of 694 patients. Sub-samples of patients were used with special consideration being given to Medicare patients. A simple logistic regression analysis was performed. The results are shown in Tables 15 and 16 below. Dx represents any other payment type.

TABLE 15

| | HYPERTENSION | | DIABETES | |
|---|---|---|---|---|
| | Adjusted | | Adjusted | |
| TYPES OF INSURANCE | Odds ratio | P | Odds Ratio | P |
| Medicare and Blue Cross | 0.83 | 0.47 | 0.42 | 0.06 |
| Medicare and other | 1.08 | 0.73 | 0.77 | 0.43 |
| insurance (private or | | | | |
| other) | | | | |
| Medicare and Medicaid | 0.61 | 0.22 | 0.72 | 0.50 |
| Medicare Only | 0.62 | 0.00 | 0.94 | 0.81 |
| Blue Cross | 0.89 | 0.53 | 1.52 | 0.16 |
| Medicaid | 1.42 | 0.24 | 0.79 | 0.53 |
| Unknown | 0.52 | 0.00 | 0.84 | 0.65 |
| Other Insurance | 0.66 | 0.02 | 0.77 | 0.39 |
| N | 1844 | | 694 | |

The results for an asthma study were as follows: an adjusted odds ratio of 1.56 (P=0.03) for the Mediplus variable (Medicare and Blue Cross+Medicare and other insurance+Medicare and Medicaid). An adjusted odds ratio of −1.04 (P=0.05) was calculated for the Medicare only variable. The population size for the asthma results was 342 (adults and elderly only).

TABLE 16

| | HYPERTENSION | | DIABETES | |
|---|---|---|---|---|
| | Adjusted | | Adjusted | |
| TYPES OF INSURANCE | Odds Ratio | P | Odds Ratio | P |
| Medicare and any type of | 0.81 | 0.25 | 0.64 | 0.11 |
| other insurance | | | | |
| Medicare only | 0.48 | 0.00 | 1.18 | 0.65 |
| Medicare and PPO | 0.89 | 0.79 | 0.23 | 0.03 |
| Medicare and HMO | 2.18 | 0.04 | 0.63 | 0.44 |
| Medicare and other types | 1.16 | 0.59 | 0.64 | 0.31 |
| of payments | | | | |
| Blue cross | 0.78 | 0.11 | 1.31 | 0.28 |
| Medicaid | 1.11 | 0.61 | 0.81 | 0.44 |
| Unknown | 0.51 | 0.00 | 0.96 | 0.92 |
| Other Insurance | 0.67 | 0.04 | 0.82 | 0.52 |
| Dx | 0.69 | 0.03 | 1.32 | 0.26 |
| PPO | 0.73 | 0.12 | 1.03 | 0.93 |
| HMO/prepaid | 0.68 | 0.02 | 0.77 | 0.30 |
| N | 1844 | | 694 | |

The results from the above study were consistent with Medicare beneficiaries who cannot access additional insurance facing lower access to hypertension drug therapy but not to diabetic drug therapy. For hypertensive patients, Medicare and HMO/Prepaid plans were more than twice as likely as Medicare patients with a fee for service to get access to hypertensive drug therapy. For diabetic care, there were Medicare patients with fee for service plans who were much less likely than Medicare patients with HMO to get access to diabetic drug therapy.

A summary of insurance profiles is shown below in Table 17. Count1 stands for a patient enrolled in one plan only. PPO Count stands for a patient with a PPO payment and only one plan. HMO Count stands for a patient with a HMO and only one plan. Dx Count stands for any other payment type and only one plan.

TABLE 17

| | HYPERTENSION | | DIABETES | |
|---|---|---|---|---|
| | Adjusted Odd Ratio | P | Adjusted Odd Ratio | P |
| PPO (A) | 0.92 | 0.84 | 0.69 | 0.59 |
| HMO | 0.42 | 0.01 | 0.86 | 0.80 |
| Dx | 0.73 | 0.13 | 2.04 | 0.02 |
| PPO COUNT | 0.82 | 0.67 | 1.10 | 0.89 |
| HMO COUNT | 2.11 | 0.05 | 0.74 | 0.62 |
| DX COUNT | 1.01 | 0.98 | 0.44 | 0.05 |
| COUNT 1 | 0.72 | 0.06 | 1.84 | 0.02 |
| N | 1844 | | 0.694 | |

### EXAMPLE 4

### Clinical Analysis of Hypertensive Patients

A clinical analysis of a population treated for hypertensive care may be performed. A number of inclusion criteria may be selected to determine the population of patients with similar conditions of illness. Illustrative diagnostic variables that could be used include, but are not limited to: malignant hypertension, intermittent high blood pressure, hypertension, hypertensive cardiomyopathy, secondary malignant hypertension and secondary hypertension. In addition, the following groups of drugs may be included: anti-hypertensive drugs, beta-blockers, calcium channel blockers, acetylcholinesterase inhibitors, diuretics, single sulfamides, combined sulfamides, xanthiques, others and unknown diuretics. The following four variables may also be included in the model: diabetes risk, ischemic heart disease risk, heart failure risk, and high cholesterol risk. One might also take into account patient sex, smoking habits, alcohol consumption, hospitalization and functional disability. The variables may be used to survey which types of drug that a particular group of patient takes so that the disease state of a patient may be linked with the economic costs of treating a particular disease state.

Using these variables, a casemix of 939 French patients diagnosed with hypertension was extracted from the four files of the consumer cross section database of Credes (1988-1991). The data that was used was self-reported data, i.e., household decision point. The casemix is shown in Tables 18 and 19 below.

TABLE 18

| Inclusion Criteria (Variable) | # of records | # of subjects |
|---|---|---|
| Diagnosis | 2491 | 2490 |
| Medications for hypertension | 2609 | 1678 |
| All medications | 4936 | |

TABLE 19

| Whole Sample | # of records | # of subjects |
|---|---|---|
| Diagnosis | 92,972 | 28,581 |
| Medications for hypertension | 33,639 | 10,042 |
| Individuals | | 27,091 |

The objective of this study was to describe the cost of hypertensive care medications, through a demand model, adopting a consumer perspective including variables such as, net price, cash payments, household characteristics. The structural equation for this model was:
Y (prescr) is a function of [S(nᵢPᵢ), d1, d2, d3, L, GHI, age, sex, rv, DI, size]
where Y (prescr) is the demand for a prescribed medication for hypertensive, Pi was the retail price of a medication record for the treatment, nᵢPᵢ was the net price paid by the consumer, for all the medication records related to hypertensive care and taking into account the rate of coverage for each medication record, and S(nᵢPᵢ) was the total of all medication records which are purchased by the consumer and paid out of pocket. d1 represented a variable for a patient who has additional insurance. d2 represented a variable for a patient who has additional private insurance. d2 represented a variable for a patient who has access to an exemption. L represented a liquidity variable—available liquid cash. GHI represents a general health index, which is relevant for controlling risk variables. The following four variables were identified—DIAB (diabetes), CHOL (cholesterol), IHD (ischemic heart disease), and CH (congestive heart failure). rv represented a risk index, which was the perceived risk to the life of the patient. DI represented disposable income of the patient. Size represented size of the household.

A statistical package (SAS) and a Proc Syslin procedure, which allows a two stage least square regression analysis, were used to analyze the data. The patients were broken into three groups based on income: a below average income group (Table 14), a low income group (Table 15), and a below average income group of elderly patients (Table 16). In the tables below, the variables are as follows: CHOL represented patients having a cholesterol diagnosis, DIAB represented patients having a diabetes diagnosis, IHD represented patients having ischemic heart disease, CHF represented patients having congestive heart failure, T-npx1 represented the net cost of medication paid by the consumer, d1 represented patients having “mutuelles” insurance (voluntary insurance), d2 represented patient having private insurance, d3 represented patients having access to condition of exemptions, r represented a below average income group of patients, tai1 represented a single person household, tai2 represented a 2 person household, tai3 represented a household with one child, and tai4 represented a household with more than one child. The results are shown below in Tables 20-22.

TABLE 20

| | Parameter estimate | |
|---|---|---|
| Variable | (Std. dev.) | Probability > T |
| intercept | 4.3448 | 0.001 |
| | (0.11535) | |
| age | 0.00135 | 0.3280 |
| | (0.00138) | |
| sex | −0.04204 | 0.1668 |
| | (0.03038) | |
| CHOL | 0.27194 | 0.001 |
| | (0.03513) | |
| DIAB | 0.20263 | 0.001 |
| | (0.04787) | |
| IHD | 0.31813 | 0.001 |
| | (0.03835) | |
| CHF | −0.31654 | 0.001 |
| | (0.06498) | |
| RV | −0.04984 | 0.0645 |
| | (0.02693) | |
| T-NPX1 | 0.00903 | 0.001 |
| | (0.00070) | |
| d1 | 0.02958 | 0.3502 |
| | (0.03916) | |
| d2 | 0.02322 | 0.6893 |
| | (0.05807) | |
| d3 | 0.13646 | 0.0004 |
| | (0.03831) | |
| r | 0.11794 | 0.0027 |
| | (0.03916) | |
| tai1 | −0.19837 | 0.005 |
| | (0.05640) | |
| tai2 | −0.20566 | 0.001 |
| | (0.04343) | |
| tai3 | −0.10198 | 0.0306 |
| | (0.04708) | |

The statistical parameters for the results in Table 20 were as follows: R-squared was 0.4045, adjusted R-squared=0.3942, F=39.333, and Prob>F=0.0001.

TABLE 21

| | Parameter estimate | |
|---|---|---|
| Variable | (Std. dev.) | Probability > T |
| intercept | 4.34318 | 0.0001 |
| | (0.15570) | |
| age | 0.00318 | 0.0116 |
| | (0.00126) | |
| sex | −0.03920 | 0.2006 |
| | (0.03061) | |
| CHOL | 0.27481 | 0.0001 |
| | (0.03547) | |
| DIAB | 0.21470 | 0.0001 |
| | (0.04816) | |
| IHD | 0.31575 | 0.0001 |
| | (0.03868) | |
| CHF | −0.32426 | 0.0001 |
| | (0.06554) | |
| RV | −0.04779 | 0.0789 |
| | (0.02717) | |
| T-NPX1 | 0.0892 | 0.0001 |
| | (0.00071) | |
| d1 | 0.02431 | 0.4457 |
| | (0.03186) | |
| d2 | 0.03137 | 0.5928 |
| | (0.05864) | |
| d3 | 0.13965 | 0.0003 |
| | (0.03863) | |
| r | 0.30810 | 0.0018 |
| | (0.09821) | |
| tai1 | −0.18211 | 0.0012 |
| | (0.05595) | |
| tai2 | −0.20371 | 0.0001 |
| | (0.04380) | |
| tai3 | −0.10913 | 0.0218 |
| | (0.04747) | |

The statistical parameters for the results in Table 21 were as follows: R-squared was 0.4006, adjusted R-squared=0.3902, F=38.589, and Prob>F=0.0001.

TABLE 22

| | Parameter estimate | |
|---|---|---|
| Variable | (Std. dev.) | Probability > T |
| intercept | 4.44967 | 0.0001 |
| | (0.11570) | |
| age | 0.00103 | 0.4615 |
| | (0.00139) | |
| sex | −0.04080 | 0.1798 |
| | (0.03039) | |
| CHOL | 0.27334 | 0.0001 |
| | (0.03518) | |
| DIAB | 0.20684 | 0.0001 |
| | (0.04784) | |
| IHD | 0.31662 | 0.0001 |
| | (0.03840) | |
| CHF | −0.31850 | 0.0001 |
| | (0.06505) | |
| RV | −0.05197 | 0.0544 |
| | (0.02698) | |
| T-NPX1 | 0.00906 | 0.0001 |
| | (0.00070) | |
| d1 | 0.03121 | 0.3252 |
| | (0.03171) | |
| d2 | 0.02733 | 0.6385 |
| | (0.05816) | |
| d3 | 0.13905 | 0.0003 |
| | (0.03834) | |
| r | 0.13572 | 0.0006 |
| | (0.03964) | |
| tai1 | −0.19608 | 0.0005 |
| | (0.05606) | |
| tai2 | −0.20366 | 0.0001 |
| | (0.04347) | |
| tai3 | −0.09984 | 0.0346 |
| | (0.04716) | |

The statistical parameters for the results in Table 22 were as follows: R-squared was 0.4050, adjusted R-squared=0.3947, F=39.292, and Prob>F=0.0001.

Models were also constructed to take into account models of expenditures based on the type of payment. The type of cash payment was differentiated into 4 variables: cash 1—patient pays cash for at least one medication for hypertension; cash 2—patient does not pay cash, because he belongs to a third party payer; cash 3—patient does not pay cash, because he has paid for other medications already and it is a grouped payment; cash 4—patient does not pay for other reasons (see Table 23). In order to control some of these interactions, a new variable was created: an interaction term between a type of payment and access to additional insurance (see Table 24).

TABLE 23

| | Parameter estimate | |
|---|---|---|
| Variable | (Std. dev.) | Probability > T |
| intercept | 4.21581 | 0.0001 |
| | (0.11541) | |
| age | 0.00243 | 0.0543 |
| | (0.00126) | |
| sex | −0.04124 | 0.1776 |
| | (0.03057) | |
| CHOL | 0.28331 | 0.0001 |
| | (0.03535) | |
| DIAB | 0.20477 | 0.0001 |
| | (0.04798) | |
| IHD | 0.32006 | 0.0001 |
| | (0.003850) | |
| CHF | −0.31555 | 0.0001 |
| | (0.06524) | |
| RV | −0.03633 | 0.1831 |
| | (0.02727) | |
| T-NPX1 | 0.00889 | 0.0001 |
| | (0.00070) | |
| d1 | 0.04665 | 0.1470 |
| | (0.03214) | |
| d2 | 0.02453 | 0.6738 |
| | (0.05827) | |
| d3 | 0.017967 | 0.0001 |
| | (0.03965) | |
| r | 0.06995 | 0.0247 |
| | (0.03108) | |
| tai1 | −0.18912 | 0.0009 |
| | (0.05686) | |
| tai2 | −0.20833 | 0.0001 |
| | (0.04379) | |
| tai3 | −0.11402 | 0.0161 |
| | (0.04728) | |
| cash1 | 0.15001 | 0.0001 |
| | (0.03404) | |
| cash3 | 0.08253 | 0.1625 |
| | (0.05904) | |

The statistical parameters for the results in Table 23 were as follows: R-squared was 0.4092, adjusted R-squared=0.3976, F=35.205, and Prob>F=0.0001.

TABLE 24

| | Parameter estimate | |
|---|---|---|
| Variable | (Std. dev.) | Probability > T |
| intercept | 4.31473 | 0.0001 |
| | (0.11186) | |
| age | 0.00271 | 0.0316 |
| | (0.00126) | |
| sex | −0.03920 | 0.2007 |
| | (0.03061) | |
| CHOL | 0.28613 | 0.0001 |
| | (0.03543) | |
| DIAB | 0.20703 | 0.0001 |
| | (0.04799) | |
| IHD | 0.31591 | 0.0001 |
| | (0.03848) | |
| CHF | −0.31614 | 0.0001 |
| | (0.06534) | |
| RV | 0.03899 | 0.1524 |
| | (0.02722) | |
| T-NPX1 | 0.00889 | 0.0001 |
| | (0.00070) | |
| d1 | 0.09891 | 0.0065 |
| | (0.03625) | |
| d2 | 0.08087 | 0.2288 |
| | (0.06714) | |
| d3 | 0.16113 | 0.0001 |
| | (0.03874) | |
| r | 0.06789 | 0.0291 |
| | (0.03105) | |
| tai1 | −0.19241 | 0.0008 |
| | (0.05693) | |
| tai2 | −0.20875 | 0.0001 |
| | (0.04379) | |
| tai3 | −0.11226 | 0.0177 |
| | (0.04379) | |
| cash1 | −0.15726 | 0.0001 |
| | (0.03860) | |
| cash2 | −0.16866 | 0.1375 |
| | (0.011346) | |

The statistical parameters for the results in Table 24 were as follows: R-squared was 0.4086, adjusted R-squared=0.3976, F=35.116, and Prob>F=0.0001.

### EXAMPLE 5

A comparison of quality of drug care indicators (scale 0-100) on three practices of a Primary Care Group in the UK were performed to assess which drug care indicators were significant. The results are shown in Table 25 below.

TABLE 25

| | Indicator | | | | |
|---|---|---|---|---|---|
| | for value of | | | | |
| Performance | info by | | | | |
| Measures | profess. | Drug care | Access | Communication | Trust |
| Indicator on | 75.46 [21.9] | 68.95 [18.97] | 54.89 [24.63] | 80.33 [16.38] | 67.72 [15.14] |
| the whole | (n = 138) | (n = 180) | (n = 234) | (n = 196) | (n = 218) |
| sample | | | | | |
| (n = 251) | | | | | |
| Practice 1 | 74.81 [25.4] | 69.07 [19.2] | 46.92 [19.62] | 80.16 [16.33] | 66.78 [13.98] |
| | (n = 52) | (n = 75) | (n = 92) | (n = 74) | (n = 99) |
| | n.s.¹ | n.s. | (1, 3)³ | n.s. | (1, 3)³ |
| Practice 2 | 78.62 [17.05] | 64.6 [19.1] | 43.01 [19.15] | 78.54 [14.95] | 63.82 [14.99] |
| | (n = 47) | (n = 59) | (n = 77) | (n = 68) | (n = 84) |
| | n.s. | (2, 3)² | (2, 3)³ | n.s. | (2, 3)² |
| Practice 3 | 72.52 [20.48] | 74.2 [17.51] | 80.26 [17.63] | 82.82 [18.06] | 73.92 [15.23] |
| | (n = 39) | (n = 46) | (n = 65) | (n = 54) | (n = 68) |
| | n.s. | (2, 3)² | (1, 2, 3)³ | n.s. | (1, 2, 3)² |
| Cronbach's | 0.70 (raw) | 0.89 (raw) | 0.90 (raw) | 0.90 (raw) | 0.70 (raw) |
| Alpha⁴ | 0.71 (stand) | 0.89 (stand.) | 0.90 (stand) | 0.90 (stand.) | 0.71 (stand) |

In Table 25 above, the superscripts represent the following: 1—n.s.: no statistical difference with other practices or conditions for the composite score; 2—The practices for which quality of care indicators differ significantly are listed under brackets and provided in bold; 3—The non parametric tests are significant, the t test is not significant, however, the distribution is not normal for the population of practice 3; 4—Cronbach's alpha has been calculated on the sample used for the analysis per practice, small variations in the coefficients can exist if we omit a number of observations for an analysis per disease and according to the treatment of missing values. However, the variations do not exceed the range of (0.1- 0.5) and therefore do not change the reliability measure of indicators.

Financial access scores per practice and per condition (including asthma) were analyzed. The results are shown in Table 26 below.

TABLE 26

| | Payment¹ | Access cost² |
|---|---|---|
| | (n = 174) | (n = 175) |
| Total sample | Exemption (E): 71.8% | 73.71 [29.14] |
| | Prescription Charge (PC): | (n = 175) |
| | 22.4% | |
| | PrePayment (PP): 5.7% | |
| Practice 1 | E: 79.7% | 73.31 [25.61] |
| | PC.: 16.2% | (n = 74) |
| | PP: 4.1% | (1, 3)³ |
| | (n = 74) | |
| Practice 2 | E: 73% | 68.58 [31.80] |
| | PC: 20.3% | (n = 74) |
| | PP: 6.8% | (2, 3)³ |
| | (n = 74) | |
| Practice 3 | E: 68.6% | 84.61 [24.33] |
| | PC: 25.5% | (n = 52) |
| | PP: 5.9% | (1, 2, 3)³ |
| | (n = 52) | |
| Condition 1 | E: 80.5% | 80.48 [24.69] |
| (hypertension) | PC: 12.2% | (n = 41) |
| | PP: 7.3% | (1, 2)³ |
| | (n = 41) | |
| Condition 2 | E: 55.8% | 61.62 [32.43] |
| (asthma) | PC: 37.2% | (n = 43) |
| | PP: 7% | (1, 2, 3)³ |
| | (n = 43) | |
| Condition 3 | E: 88.6% | 79.54 [26.01] |
| (diabetes) | PC: 9.1% | (n = 44) |
| | PP: 2.3% | (2, 3)³ |
| | (n = 44) | |

In the above table, the superscripts represent the following: 1—Type of payment for medicines; 2—Access without worrying about cost on a scale 0-100; 3—The practices or conditions for which access indicators differ significantly are listed under brackets and provided in bold.

A comparison of two trust indicators per practice and per condition (with and without physicians' cost awareness) was performed. The results are shown in Table 27 below. The practices for which trust indicators differed significantly are listed under brackets and in bold.

TABLE 27

| | | Trust on clinical judgement |
|---|---|---|
| Performance | Trust on clinical | and physician's cost |
| measure | judgement/knowledge only | awareness |
| Indicator on | 79.23 [8.31] | 68.73 [17.78] |
| the whole | (n = 218) | (n = 218) |
| sample | | |
| Practice 1 | 77.24 [17.84] | 68.81 [16.41] |
| | (n = 99) | (n = 99) |
| | | (1, 3)¹ |
| Practice 2 | 77.17 [18.90] | 62.97 [18.83] |
| | (n = 84) | (n = 84) |
| | | (2, 3)¹ |
| Practice 3 | 83.75 [16.80] | 76.59 [18.28] |
| | (n = 68) | (n = 68) |
| | | (1, 2, 3)¹ |
| Condition 1 | 80.10 [18.82] | 67.18 [18.30] |
| | (n = 51) | (n = 51) |
| | n.s. | n.s. |
| Condition 2 | 75.46 [19.64] | 67.00 [16.16] |
| | (n = 52) | (n = 52) |
| | n.s. | n.s. |
| Condition 3 | 80.57 [17.25] | 68.59 [18.27] |
| | (n = 58) | (n = 58) |
| | n.s. | n.s. |

### EXAMPLE 6

UK patients' satisfaction on their health system in comparison with other European consumers are shown in Table 28 below. The Euro barometer data are used before the survey, in order to explore patient satisfaction on pharmaceutical services. Such surveys are sensitive and may be easier to perform within an international collaboration.

TABLE 28

| Patient Satisfaction score on | |
|---|---|
| the health system | Eurobarometer 1996 |
| Spain | 35% |
| The UK | 48% |
| Germany | 65% |
| France | 65% |
| Belgium | 70% |
| Denmark | 90% |

Source: European Commission

When introducing elements of the examples disclosed herein, the articles “a,” “an,” “the” and “said” are intended to mean that there are one or more of the elements. The terms “comprising,” “including” and “having” are intended to be open ended and mean that there may be additional elements other than the listed elements. It will be recognized by the person of ordinary skill in the art, given the benefit of this disclosure, that various components of the examples can be interchanged or substituted with various components in other examples. Should the meaning of the terms of any of the patents, patent applications or publications incorporated herein by reference conflict with the meaning of the terms used in this disclosure, the meaning of the terms in this disclosure are intended to be controlling.

Although certain features, aspects, examples and embodiments have been described above, it will be recognized by the person of ordinary skill in the art, given the benefit of this disclosure, that additions, substitutions, modifications, and alterations of the disclosed illustrative features, aspects, examples and embodiments are possible.

1. A method comprising:
selecting at least one variable;
generating a cost sensitivity index using the selected at least one variable; and
determining a treatment decision shift using the generated cost sensitivity index.

2. The method of claim 1, further comprising configuring the at least one variable as a physician variable.

3. The method of claim 1, further comprising configuring the at least one variable as an implicit cost variable.

4. The method of claim 1, further comprising configuring the at least one variable as an explicit cost variable.

5. The method of claim 1, further comprising configuring the at least one variable as a patient variable.

6. The method of claim 1, further comprising generating a treatment decision using the generated cost sensitivity index to determine the treatment decision shift.

7. The method of claim 6, further comprising selecting a health care decision based on the generated treatment decision.

8. The method of claim 6, further comprising comparing the cost sensitivity index with a lookup table to generate the treatment decision.

9. The method of claim 1, further comprising surveying a group to generate a response to the at least one selected variable.

10. The method of claim 9, further comprising configuring the group to be physicians.

11. The method of claim 9, further comprising configuring the group to be patients.

12. The method of claim 11, further comprising configuring the at least one variable to be selected from the group consisting of patient affordability, patient demand for cheaper medication, severity of the disease or disorder, and patient copay for a selected comedication.

13. The method of claim 1, further comprising selecting a plurality of variables.

14. The method of claim 13, further comprising ranking the variables from most important to least important to generate the cost sensitivity index.

15. The method of claim 14, further comprising assigning the ranked variables a score.

16. The method of claim 14, further comprising weighting one or more scores assigned to the variables.

17. The method of claim 16, further comprising generating the cost sensitivity index from the weighted scores.

18. The method of claim 17, further comprising summing the weighted scores to generate the cost sensitivity index.

19. The method of claim 17, further comprising averaging the weighted scores to generate the cost sensitivity index.

20. The method of claim 17, further comprising summing the weighted scores and comparing the summed weighted scores to a lookup table to determine the treatment decision shift.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. Cancelled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. A method comprising:
surveying a group of patients;
generating a quality index based on survey results from the surveying of the group of patients; and
determining a treatment decision shift using the generated quality index.

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. A method comprising:
surveying a group of patients;
generating a risk index based on survey results from the surveying of the group of patients; and
determining a treatment decision shift using the generated risk index.

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. A system comprising a processor and a storage unit and operative to perform a market simulation using an index selected from one or more of a cost sensitivity index, a quality index or a risk index.
